(19) United States
(12) Patent Application Publication
(10) Pub. No.: US 2019/0088159 A1
(43) Pub. Date: Mar. 21, 2019

(54) Quantified Scientific Well-Being Evaluations, Interventions and VR Games

(71) Applicant: Paul Ash Minturn, La Jolla, CA (US)

(72) Inventor: Paul Ash Minturn, La Jolla, CA (US)

(21) Appl. No.: 15/706,443

(22) Filed: Sep. 15, 2017

(51) Int. Cl. G09B 19/00; G09B 7/00; G09B 5/02; A63F 13/85; A63F 13/52; G06F 19/00

(52) U.S. Cl. CPC G09B 19/00; G09B 7/00; G09B 5/02; A63F 13/85; G06F 19/3487; G06F 19/3431; A63F 2300/8082; G06F 19/363; A63F 13/52

(57) ABSTRACT

The embodiments of this invention provide: Quantifiable Scientific “10” Point Well-Being Evaluations, Customized Interventions, Business Cost Containment Programs and Realistic VR Games resulting in more accurate assessing and tracking of well-being, optimal health, ideal fitness levels with superior detection and prevention of catastrophic health crises by comparing participants against “Super Healthy Human Measurements” and correlating them to a series of Scientifically “10” Point Assessed Well-Being Scales that are actuarially more accurate than standard “Two (2)” point medical (“normal/abnormal”) assessments, or any HRA Scales and/or the limited “Fit” or “Unfit” fitness evaluations. Consequently, individuals and companies can achieve higher levels of “Well-Being” and performance management utilizing intervention protocols and custom self-educating VR Games based on an individual's current measurements on the “10” Point Scales. The VRs dramatize realistic consequences for lifestyle choices through VR adventures, thus educating and motivating participants on what choices will create the highest scores of Optimal Well-Being.

This application is a continuation-in-part of co-pending U.S. patent application Ser. No. 14/737,452 entitled “Quantified Well-Being Evaluations, Improvement Programs and Scientific Wellness Video Games” which was filed on Jun. 11, 2015, the entire disclosure of which is hereby incorporated by reference.

### BACKGROUND OF THE INVENTION

### 1. Field of the Invention: Technical Field

It is a well-known fact that traditional/allopathic medicine is based on a sickness model rather than a wellness paradigm. Most individuals visit their doctor only when they are in desperate need of help which limits health care to treating crisis-oriented symptoms. Causative factors are rarely if ever researched or considered important. It should be obvious that symptoms of pain or dysfunction are indications that something is wrong. Unfortunately, doctors are politically, professionally and legally limited to treating the symptoms, prescribing toxic medicines, do surgeries rather than heal or “make whole,” and try to fix rather than prevent. Too often, many major dysfunctions and diseases leading to catastrophic conditions, early aging, serious illness and even death could have been safely prevented had they been identified with early wellness screenings, often a long time before the appearance of any devastating symptoms needed for a valid medically required Government Approved Code (CODE) diagnosis.

Today's lifestyles are riddled by numerous personal, business and environmental stressors, dysfunctions, early aging factors and compromised health. Recent politically motivated attempts to fix the astronomical costs of these healthcare crises have only increased the number of problems, ER visits including many preventable catastrophic conditions. For pure economic reasons alone, it is time to confront these alarming and dramatically increasing health statistics by addressing them pragmatically, realistically and scientifically. The first question asked by a reasonable health scientist would be, “What caused this symptom or the poor health situation?” Translated into terms of optimal wellness, Well-Being Professionals ask, “What are the causal factors leading to cardio-vascular diseases, cancers, arteriosclerosis, eating disorders, obesity, diabetes, autism, opioid addictions,” etc. Many published science studies have demonstrated, for example, a strong correlation between lung cancer, emphysema and smoking. Qualified Ethical Well-Being Professionals need new tools to explore the reasons why, for example, people wish to continue smoking even when fully aware of the serious risks and hazards of nicotine poisoning.

By addressing causal factors on all levels (biological, physiological, mental, spiritual, emotional, social, attitudinal, economics, political, etc.) Quantifiable Scientific Well-Being Methods can:

a) assist individuals in achieving and maintaining optimal health potentially providing for themselves a more energetic and productive lifestyle at all ages.

b) provide much earlier detection of preventable diseases with proven intervention systems.

Today, rapidly increasing health care costs negatively affecting the bottom line are a serious priority for every business, large or small. It is essential that smart employers seek cost effective health care plans, regardless of the politics. Many businesses utilize management concepts to control risks in keeping their businesses financially healthy but often ignore managing their most important asset, i.e., the optimal health and continued performance of their key employees.

The pioneers of the Scientific Well-Being Movement include the numerous ethical, sincere, dedicated health scientists and medical researchers of the past who have searched the world for the keys to quantifiable scientific well-being, optimal wellness, fitness, longevity and healthy-aging. Many of these pioneers spent their lives in search of valid information and data that would unlock the secrets of achieving and maintaining individual super-health, scientific well-being, optimal wellness, ideal fitness, great longevity and an exciting quality life beyond the present average life spans.

In their quest for the modern “Fountain of Youth,” these pioneers have left a legacy of valuable data and information. The compact personal computer has made it possible to use this data to address many of the questions concerning optimal health and great longevity at a much more sophisticated level. Careful examination of this scientifically processed data has created the potential for establishing achievable optimal health and fitness guidelines. Thus, for the first time in history, smart people have scientific methods for seeking the “Fountain of Youth” and “Staying Well.”

The present invention is made possible because of more than three dozen years of innovative investigations conducted by several noteworthy pioneer groups of composed of passionate health scientists, sports fitness experts, medical/dental researchers, well-being and optimal wellness professionals, including:

A. During the 1970s, 1980s and 1990s, a sizable body of scientifically objective data was collected that involved more than 1,000 qualified health care professionals and wellness research scientists (longevity doctors, preventive dentists and university professors with expertise in such fields as: medical research, ideal fitness, optimal biochemistry, healthy nutrition, exercise physiology, longevity, preventive dentistry, psychology, sports medicine, and more). These brave pioneers collected objective physical chemistry data from millions (over 3M) of interested and supportive individuals (identifying a large group of super-healthy people totaling over 12,000, mostly in North, Central, South America and the Pacific Rim) of all ages who had at least a minimum of ten to fifteen years or more “completely free” from any form of unhealthy eating habits, debilitating disease/sickness or symptoms, including: severe headaches, intestinal disorders, hypertension, obesity, cancer, “Flus” and/or the “Common Cold,” etc. The battery of laboratory and physical tests used by the team included: blood, sputum (saliva) and urine chemistries, hair analyses, plus a basic set of physiological measurements, viz., blood pressure, height, weight and posture as well as some standard psychological tests. The raw data from this large carefully selected group of optimally healthy and well people was collected, collated and entered into the first “Scientific Wellness and Optimal Body Chemistry Data Base.” Additionally, during these decades, volunteers with only average test results that were willing to participate in experimental uses of high quality herbs and nutritional supplements, natural medicines and specific wellness interventions were enlisted. This enlarged the number of optimally healthy and well people in the “First Wellness Data Base” to several hundred thousand by the early 1980s. This “Original Wellness Data Base” became the first body chemistry internal component for actuarially creating a scientifically accurate “Ten-Point Scale,” where the “8s, 9s and 10s” correlated to most ideal or optimal measured levels of wellness. When this team searched the world for other studies in optimal body chemistry or wellness, they were surprised to discover that no one had designed a scientific quantifying system that could measure optimal health and body chemistry or fitness against any type of optimal ranking set of scales. The raw data from these measured groups of optimally healthy living individuals formed the first known identifiable scientific markers and ranges for scientifically measuring super-health, quantifiable well-being, optimal wellness and ideal fitness.

B. The first known “Measurements of Ideal Sports Fitness” had its beginnings in the early 1970's at the University of California, San Diego (UCSD). This university fitness research continued into the 2000s. It included basic exercise physiological and medical laboratory data on such factors as: age, height, weight, smoking, sex, family health history, personal medical history, activity/exercise levels, blood pressures, body (fat) composition, diet, psychological and mental health parameters (MMPI and CPI tests) and factors, other lifestyle habits, exercise (aerobic) heart rates, oxygen utilization, recovery heart rates, pulmonary vital capacity and forced volume, resting and stress (exercise tolerance) ECGs and over 59% of the participants had their blood sugars and toxins, blood cholesterol and triglycerides and other lipid chemistries, proteins and liver function measured. Over the years, thousands were tested for their levels of fitness and cardiac risk with these measurements. This UCSD cardiac risk study included a cardiac risk questionnaire which assessed: (1) both personal and family medical histories, (2) a few personality and psychological factors, (3) dietary habits, (4) exercise levels, (5) smoking, and (6) working and living environments. Additionally, technicians took specific physical tests and measurements which included: blood pressures (systolic/diastolic), body (fat) composition, pulmonary forced volume and forced vital capacity, resting heart rate, exercise heart rate, recovery heart rate, oxygen utilization, flexibility and strength, resting ECG, and stress ECG (exercise tolerance type). Furthermore, the research team collected objective blood chemical laboratory analyses, such as: total blood cholesterol and triglycerides, HDL, LDL, glucose, proteins and liver function. By 1980, more than 12,400 people that had participated in this battery of comprehensive tests and measurements measured “OPTIMAL” in determining their cardiovascular fitness and wellness levels as well as “Extremely LOW” in their major risks factors (if any). When the team of wellness and longevity researchers, health care professionals, computer scientists and electronic engineers realized the valuable ideal body chemistry data that had been collected on super-healthy individuals and the raw data on super-fit people collected at UCSD, they decided it was time to combine these sets of data into the first and only “Comparative Scientific Wellness Data Base.” During the 1980s, this OPTIMAL Well-Being Data Base resulted in supporting the actuarial creation of an expanded number of ten-point scales, where the “8s, 9s, and 10s” were correlated to actual living humans with ideal or optimal measured wellness (not to any theoretical norms of the conventional medical or fitness measurements of the average two-point systems). It was this enlarged Comparative Scientific Wellness Data Base that convinced the BCBSA actuaries and their management team to become trend setters by creating and publishing the first BCBSA “Health and Fitness Profile” in the early 1980s.

C. As a leader in the health insurance industry, the creation of the Blue Cross and Blue Shield Association's “Staying Well” and “Your Healthy Best” books and the BCBSA “Health and Fitness Profiles” for corporate wellness programs fueled the growth of a new focus on wellness throughout the 1980s and 1990s, a movement that reached over 150 million people by the turn of the century. Unfortunately, the last dozen years has seen a politically motivated shift and decline in funding and implementing of both business or community wellness programs. This tragedy turn of events has resulted in a dramatic increase in the number of catastrophic diseases being treated by the medical community and an associated skyrocketing in conventionally managed health care costs. With many prevention and wellness programs no longer available to the community, both insurers and medical facilities have faced insurmountable cost increases in providing basic health care programs. The shift away from prevention, early detection and wellness has caused many providers to even leave the health care industry and some to go out of business. Consequently, a significant return to the innumerable benefits of “early detection” through optimal wellness screenings, plus scientifically based well-being education and improvement programs that have proven prevention and scientific well-being interventions, especially those associated with the present embodiments of this invention are desperately needed.

### 2. Descriptions of the Related Art

### Descriptions of Background Art

There are still numerous but ineffective health risk potential summaries (HPSs) and some surviving health risk appraisals (HRAs) that can only quantify up to an “average” numerical score of “5” on the unique Scientific Well-Being ranking 10-Point Scales. Most of these risk evaluation data bases are based on the standard but very limited 2-Point Evaluation Scales (“Normal” or “Abnormal”) of the conventional “illness industry,” which are completely limited to comparing the latest risk statistics on death and disease (the standard mortality and morbidity indices) of the government controlled CDC or the updated actuarial tables of the insurance industry.

All these politically controlled and popular risk analyzing methods and systems are fundamentally flawed and extremely poor predictors of catastrophic illnesses, simply because they do not have any ideal models or comparative data from measurements of “super-healthy living humans” to compare or contrast their data against. By lacking any quantified or validated Scientific Well-Being or Optimal Health and Ideal Fitness Data, these risk assessments can only actuarially identify “Average to Poor” health in the functional individuals who are not in the hospital at this time. These limited 2-Point Evaluation Scales (“Normal” or “Abnormal”) rely only on limited risk data (which ignores causative factors and only focuses on active symptom diagnosis and treatment), for their interpretation of potential or future pending risks.

Consequently, the typical medical evaluations (such as a doctor's physical exam) plus all of the HPSs and HRAs are totally useless in measuring the ideal parameters of “Super-Health, Quantifiable Scientific Well-Being, Optimal Wellness and Ideal Fitness. Thus, the standard basic “TWO POINTS” (normal/abnormal) medical evaluations are extremely poor at accurately predicting most future minor or major health crises, because they cannot measure or track any of the small incremental indicators, changes or deteriorations in a person's present or potential future health risks.

Many years ago, a health potential summary (HPS) filed for a patent (Fuller et at., U.S. Pat. No. 4,464,122). Fuller assesses only a limited number of subjective lifestyle health risk factors and does not include any objective physiological or laboratory health risk factors. Thus, Fuller's HPS cannot objectively or scientifically measure, quantify or evaluate the most important optimal well-being, spiritual, psychological, physiological or laboratory wellness parameters.

In the past several decades, every HRA attempt to evaluate, quantify and/or predict future health risk factors has failed actuarially for at least four major reasons:
I. First (1st). The measurement of risk factors was extremely limited because they were not measured, correlated, compared or tracked against any optimal health and fitness data or scales. Risk factors were entirely based on CDC and insurance data from individuals with only “average to poor health.” The absence of identifiable or diagnosable health risks or symptoms never actually equaled super-health, scientific well-being, optimal wellness or ideal fitness.
II. Second (2nd). All of the Health Potential Summaries (HPSs) and Health Risk Assessments (HRAs) were exclusively founded on a “generally accepted but erroneous assumption” that the absence of most major risks (or their associated risk factors) meant that a person could be generally classified as “LOW RISK” or labeled in “EXCELLENT HEALTH.” This error has proved to be a complete fallacy. This assumption, however, was faulty for two basic reasons: (a) it was much too simplistic, and, (b) it turned out to be too good to be true. Since conventional doctors were only trained to diagnose symptoms and treat illnesses, he or she would never be able to identify or quantify a well person based on super-healthy/optimal well-being indicators. Many individuals that had just had their physical exam and were pronounced in “excellent health” by the attending physician, ended up in ER with a major or serious catastrophic disease only a few minutes, days or weeks later. What could have gone wrong so fast?
III. Third (3rd). All current major risk and medical diagnosing systems and procedures used as background for annual physicals, family history, HPSs and HRAs which are limited to assessing only major SYMPTOMS or active CONDITIONS. None are designed to discover root causative factors associated with serious sickness, disease or death. The medical industry has attempted to correlate these risk factors to the CDC indexes and the major insurance morbidity and mortality tables. Unfortunately, without an actuarial model of scientific well-being, optimal wellness, super-health and ideal fitness, such correlations could never be possible.

IV. Fourth (4th). In the final analysis, ALL standard medical physicals, HPSs and HRAs have failed to statistically predict even minor future risk(s) factors and/or potential claims because they are only correlated to the CDC data and/or to the insurance “morbidity and mortality tables” consisting of “Average to Poor Healthy” people (i.e., the general population), but were never compared to any scientific well-being, optimal wellness, super-health and ideal fitness data.

All known conventional or standard medical risk assessments are based on a basic “TWO POINTS” Scale and separated into “NORMAL” and “ABNORMAL” physical and laboratory tests and measurements. The doctor or other health professional that conducts these risk assessments can only decide whether to hospitalize the patient “TODAY” due to a diagnosable symptom(s) or “LATER.” In other words, if there aren't any diagnosable symptoms, patients are frequently but erroneously told that they are in “excellent health.” The average physician never sees anyone in “excellent health.”

A few years ago, another 2-point HRA type of “MULTI-PLAYER ROLE-PLAYING LIFESTYLE-REWARDED HEALTH GAME” that was designed as an integrated health management (IHM) platform and service oriented architecture (SOA) framework filed for a patent (Kil, et at., U.S. Patent Publication 20080146334). This complex invention provided apparatuses, computer media, and some methods for supporting lifestyle-reward health games, in which execution might be altered based on certain health behavior choices of the participant. Input data from “Average to Poor Healthy” people that was assumed indicative of their health behaviors was obtained and converted into a gaming parameter which was applied to a lifestyle-reward health game in order to alter the execution of the lifestyle-reward health game. A potential reward parameter for the participant was then determined based on a utility function, and the reward parameter could be invoked when the participant was playing the life-reward health game. Feedback to the participant was given during the execution of the lifestyle-reward health game, where the feedback was indicative of the participant's health behavior. The game included a somewhat limited avatar which was depicted during the execution of the lifestyle-reward health game to illustrate a predicted health condition, in which the depiction was altered by changing the timeframe (not the causes) of the predicted health condition. However, this invention can never be compared to the present invention, because Kil, et. al., had the same limitations as the common HRAs and the doctor's medical annual physical. The invention was severely limited because there was no optimal health or well-being data base to compare the predicted health condition to, since the game was utilizing the standard conventional “Health Risk Assessments” (HRAs) or the CDC data, or some conventional medical risk measurements and some common “Fitness Evaluations,” all of which are based on limited “TWO POINTS” ranges and separated into “NORMAL” and “ABNORMAL” or what is called “FIT” or “UNFIT” in the fitness industries when physical assessments are determined by fitness trainers.

In sharp contrast to the present “TWO POINTS” risk assessments (“NORMAL” and “ABNORMAL”) offered by the best and most advanced medical and general fitness evaluations, the present invention offers a quantum advanced evaluation system based on a gradual TEN POINT SCALE, i.e., from a “1” Level Score being ultra-high risk (or often in an Intensive Care Unit) to an actuarially quantified “10” Level Score which represents exceptional well-being with graduated numbers in between ONE and TEN. This “TEN POINT SCALE” has repeatedly been quantified and validated via actuarial schemes and comparisons to a large data base of carefully tested human beings who had participated in comprehensive scientific well-being evaluations.

There are major differences between any 2-Point Medical Evaluations and the 10-Point Scientific Well-Being Evaluations. The 2-Point Assessments are unable to quantify or track tiny incremental changes in a person's health, whereas the 10-Point

Evaluations embodied in this invention are capable of tracking small gradual changes in both risk and wellness levels. In the conventional 2-Point System, everyone has to wait until the patient experiences a serious diagnosable symptom which then can be identified as a major health risk. Often this high-risk condition may include a “911” emergency drama with the patient being rushed to ER in the nearest hospital.

Only the present invention embodies a proven 10-Point System that allows both the individual and adequately trained health professionals an assessment system that can track small gradual changes in either risks and/or improvements. This provides significant information to both an individual and a trained optimal health professional to assess what is working or not working in the lifestyle attitudes and behaviors as well as in any changes that ultimately determine a person's level of risk and/or well-being. The ability to micro-manage quantifiable scientific well-being with tested protocols and custom interventions for reducing major risk factors and improving a person's wellness takes the guess-work out of “Staying Well.”

The Quantifiable Scientific Well-Being Evaluations, Intervention Programs and VR Games might be comparable to an advanced and very complicated evaluation system in “Geometry.” A simple math example will help explain the differences between the standard 2-Point based HRAs and medical assessments and the 10-Point Scientific Well-Being Evaluation Methods. When a person wants to do a volumetric measurement of several objects, such as: a simple round ball, cube or rectangular object or shape, he or she can use basic high school geometry. The high school trained math person can accurately quantify the volume (or “space occupied”) by the simple objects with reasonable closeness to the exact volumetric measurement. This simple math assessment works well if the object is homogeneous and not irregular in shape. However, the high school trained math person using simple first year geometry can only guess or approximate the volume of an irregular shape, such as: an irregularly shaped rock, a banana, or an asteroid. In order to accurately measure the volume (“space occupied”) of such more complex objects, the math person must first learn, master and be able to use a much more sophisticated math system, such as upper division solid analytic geometry combined with triple integral calculus to accurately measure and quantify the volume of these irregular objects.

In the above simple volumetric example, a 2-Point Medical Evaluation can be likened to the high school math person that can only measure the volume of simple objects with basic geometry whereas the 10-Point Scientific Well-Being Evaluations can be compared to the more advanced math trained person using solid analytic geometry combined with triple integral calculus to more accurately quantify unusually shaped or irregular objects. In other words, using any 2-Point Medical or HRA Evaluation System does not provide for any reliable or accurate measurement of small, gradual or incremental tracking of changes in either health risks or a person's well-being.

### BRIEF SUMMARY OF THE INVENTION

The quantifiable scientific well-being and optimal wellness aspects of the present invention's methods offer the following unique features:

(1). It allows an individual's assessments to be compared and correlated to a more stringent, advanced and updated optimal criteria of “super-healthy individuals and groups” of measured and assessed living examples of quantifiable scientific well-being, optimal wellness, super-health and ideal fitness which consisted of “scientifically validated extremely healthy people.”

(2). It emphasizes the many positive benefits and major “longevity/staying well” contributions of knowing and following an exciting life purpose and important mission combining super-healthy lifestyle choices, spiritual and positive mental outlooks as important causative factors that result in achieving and maintaining “super-health, quantifiable well-being, optimal wellness and ideal fitness levels” as well as realistic strategies and potential goals of completely reducing and/or eliminating most major predictors of diseases or catastrophic health risks.

(3). It contains updated actuarially determined important global categories of super-health, quantifiable well-being, optimal wellness and ideal fitness status, and attainable levels of future well-being, making it among the first and most complete, validated, accurate and comprehensive method of “Achieving and Staying Well” that is available today.

(4). It embodies methods that continue to motivate participants in a positive direction by encouraging frequent re-testing and measurements of the on-going negative impacts of stress, unhealthy habits and poor lifestyle choices on the foundational spiritual, intellectual, emotional, mental, psycho-physiological systems of the body/mind/soul/spirit human organism, including quantifiable devastating effects on the cardio-vascular and immune systems.

(5) It allows participants the opportunity to take the guesswork out of proactively managing one's own levels of super-health, quantifiable scientific well-being, optimal wellness and ideal fitness status, and attainable levels of measurable future improvements.

(6). It provides on-going invaluable data and information that dramatically improves the ability of smart people to predict and quantify their own potential preventive medical utilization needed and future levels of super-health, quantifiable scientific well-being, optimal wellness and ideal fitness plus any trackable benefits from any chosen well-being improvement programs.

(7). It offers a new and exciting high-tech VR adventures through individualized and customized (to the actual expressed goals, empirically measured physical and nutritional needs and challenges of each person) custom computer generated “VR Games” whereby a smart participant can study his or her future “Super-Health, Quantifiable Scientific Well-Being, Optimal Wellness and Ideal Fitness Output Reports” and then explore in a safe virtual world the probable outcomes and consequences of making either “GOOD” (well-being improving choices) or “bad” (addictive, selfish, self-destructive, potentially harmful or disease causing choices including unhealthy outlooks and attitudes). These customized computer generated “VR Games” will be so factual and realistic (based on the actual empirical data and measurements taken by any certified wellness technician, the self-reporting subjective information provided by the participant, and the scientifically objective lab analyzes of body fluids) that these adventure filled “VR Games” are very likely to become a powerful and influential motivating positive influence towards consistently making “beneficial” lifestyle choices the gradually improve a person's rankings on the “Super-Health, Quantifiable Scientific Well-Being, Optimal Wellness and Ideal Fitness Scales” which can easily improve a person's actuarial chances of healthy-aging, increased optimal wellness and scientific well-being plus an exciting high-quality future life purpose and mission complete with increased statistically improved longevity and healthy aging potentials.

### URGENT NEED FOR THIS INVENTION

Due to the disastrous misguided politically motivated mistakes in government mandated health care programs during the most recent decade, there is an “Urgent and Critical Need” for the present invention and its Methods For Quantifying Scientific Well-Being, Optimal Wellness, Super-Health and Ideal Fitness which actuarially compares and contrasts the input data to a more stringent data base of super-healthy people that experienced over 15+ years without any minor Illnesses, symptoms or need for any prescribed medications.

There have been some surprising results in field testing the Super-Healthy, Quantifiable Scientific Well-Being, Optimal Wellness and Ideal Fitness VR Games. It has become apparent that the utilization of this modern popular technology offers one of the most exciting motivational tools ever tested or imagined. When compared to the successes of other embodiments of the present invention:

(1) the individualized Scientific Well-Being and Optimal Wellness output charts complete with positive suggestions for improvements, or,

(2) participation in the Scientific Well-Being and Optimal Wellness educational intervention programs, or,

(3) the learned advice and suggestions for improving one's Scientific Well-Being and Optimal Wellness Scores given by a qualified optimal health professional,

(4) the VR Game's virtual reality adventures had the highest consistency in successfully motivating a person to make repeatable positive improvement choices and create new habits in compliance with the super-healthy suggestions made by the Game's Fun Loving Well-Being Avatar, which is actually created by the participant as an integral part of the VR Games.

Within the VR Games, the Avatar (as created by the participant) usually became the participant's best friend in the VR Games, because the Avatar understands the participant better than any outsider could since he or she was actually a smarter internal aspect of the person playing the VR Games. It is presumed that one of the reasons for this higher compliance level is likely because the reasonable suggested positive and/or negative future choices were intimately related to the person's own past and current habits and choices. The wise Avatar apparently knew or guessed what the participant was willing to do or not do when it came to giving up unhealthy habits or patterns and making healthier choices, whereas an outsider would only be guessing.

Furthermore, as the participant explores and learns from the custom exciting adventurous discoveries inherent in the “Customized Fun Scientific Well-Being and Optimal Wellness Computerized VR (3D) Games,” new intriguing and desirable options appear in the Games. By following the probable scenarios of alternatively choosing “positive” options and/or clearly “negative” choices in the Game's adventures and dramas, the participant can safely explore their own future realistic probable outcomes and consequences, be they positive or disastrous. Taking full advantage of this modern high-tech self-educational system will ultimately result in many exciting personal scientific well-being and optimal wellness stories and rewards made available to the VR Game's participants from ethical sponsors. The intrinsic beauty and magic of the VR Game's experiences is that the game creates both enjoyable, fun as well as some potentially scary but realistic self-educational scenarios (i.e., “learning lessons”) that quickly let a person safely explore realistic life experiences and dramas and their probable outcomes and consequences without any serious or devastating personal scientific well-being and/or optimal wellness damages. As the participant continues to play the VR Games, he or she can learn how to improve their own personal scientific well-being levels and optimal wellness scores to the point that they can share their successes with family, friends and business associates. This unexpected benefit with its phenomenal compliance levels really excited the Scientific Well-Being and Optimal Wellness Researchers and Supportive Professionals making the present invention even more valuable than had ever been anticipated.

The present invention may soon become the most reliable source or repository of Valuable Scientifically Accurate Personal Scientific Well-Being, Optimal Wellness, Total Self-Care Information and Non-Political Resource for a guaranteed Sustainable Global Healthy Future and Ecological Balanced Environment for the smarter super-healthy, fulfilled, functional and peak performing survivors of the human race. The innovative technologies of the present invention are a quantum paradigm shift from the disastrous, often barbaric and limited conventional practices of diagnosis and treatment of mostly symptoms and related diseases because the current technologies and procedures of traditional medicine primarily focus on the money making economics of identifying and treating symptoms with little or no attention given to the causative factors. All too often, the discovery or diagnosis of the dangerous disorder and its symptoms comes long after serious preventable damages have already occurred to the human organism.

We live in a modern age where technological advances could easily eliminate chronic, catastrophic diseases and premature deaths. However, just the opposite is happening around the world. Instead of the elimination of preventable illnesses, there is a rapidly escalating global increase in substance abuses, preventable cardiovascular diseases, diabetes, cancers, obesity, strokes, autism, untreatable super-bugs that keep mutating faster than new toxic prescriptive medicines can be invented, and many catastrophic and debilitating pandemics and health crises that are largely a side-effect or result of greedy agendas, including unethical and criminal business and economic strategies.

Since the turn of the century, the need for natural organic non-toxic chemical and GMO-free foods has dramatically increased, creating many mega health food stores eager to profit from servicing the needs of the smarter individuals who are passionately dedicated to optimal health and fitness. During these same years, however, the number of global idiots and dummies who consume fast, junk, processed, chemically preserved and taste enhanced foods has grown at even a faster rate. There has been an even greater astronomical increase in the global masses of people who are blindly consuming many GMO and toxic carcinogenic chemically laced eats and drinks, regardless of any future health risks. These are the billions of people who ignorantly depend entirely on the illness industry to replace their worn-out body parts with organ transplants or computer 3D printed plastic parts, just like one replaces worn out parts on our computers, vehicles, appliances and airplanes. Consequently, the modern unethical news media has a never ending but lucrative source of tragic, dramatic and tear jerking stories related to the new super bugs and the expanding global pandemic health crises. The narrow and limited approach in modern medicine is not prevention based or proactive and may be likened to flying an aircraft or driving a land vehicle without any lubricating oil in the engine long after the warning lights or gauges on the dash board have indicated a serious problem that needs immediate attention.

The need for the present invention increases daily because of its focus on early identification of causative factors as well as on achieving and maintaining measurable optimal wellness and quantifiable total scientific well-being. It is time to take advantage of some technological advances in lab analyses of body fluids and the many new fitness devices that can assist the smart proactive oriented people in gathering data. Presently there are many gadgets, such as: smart watches, sophisticated phones, tablets, PCs and computerized smart phone Apps that provide valuable information without needing to book an appointment with a busy health professional or conventional doctor or visit a lab for a prescribed medical blood, urine, stool or saliva test.

For a variety of reasons, the present invention does not just focus on such negative items as preventing or even early-detection of major risks or poor health conditions leading to debilitating or catastrophic diseases. Instead, it assists individuals in being able to create a reasonable path to going way beyond just “average ordinary health and functionality.” Using the present invention's methods and applications, an ordinary person can simply, empirically, scientifically and objectively quantify important basic health, quantifiable scientific well-being and optimal wellness parameters.

The measurements, assessments and lab analyzes of the present invention comprise a variety of accurate data gathering methods, including: bio-physiological pulses, BMI, standard blood pressures, circulation cardio-efficiency and environmental pulmonary wellness measurements with objective customized assessments of life purposes and missions, personal outlooks and core beliefs, lifestyle attitudes and habits, spiritual values, nutritional eating and drinking habits, movement and physical exercise behaviors, relationship wellness dynamics and then contrasting such data to vital scientific and quantifiable accurate laboratory evaluations of immuno-vitality, urine, endocrine health, important blood lipids, sugars (glucose), hormones, and other biological and physio-chemistries as needed on an even more stringent definition criteria of “super-healthy individuals” that was not available in the past.

This invention is routinely capable of providing any participant with vital scientific well-being and valuable prevention information of deteriorating hidden health conditions through a series of 10-Point Quantifiable Scientific Well-Being and Optimal Wellness Scaling and Factoring Formuli long before a crisis situation exists. The data generated by this invention is invaluable to the rapidly growing number of smarter people around the world who are sick and tired of the limited self-serving inhumane disease oriented economic agendas, mind-sets and limited paradigms of the standard traditional illness industries.

The present invention also provides reasonable alternative ethical answers, options and realistic solutions to the billions of people that currently rely upon the poorly trained health professionals who are solely focused on the economics of diagnosing and treating symptoms, without considering the causative factors or the inevitable consequences of unhealthy lifestyle choices, such as: pigging out on convenient fast, junk, highly processed or GMO foods and drinks laced with numerous toxic chemicals, preservatives, MSG, pesticides, dangerous artificial sweeteners, disease or cancer causing hormones, and other substances that are known to be carcinogenic.

Many proactive optimal health and fitness minded intelligent individuals that are dedicated to the current challenge of achieving and maintaining their high-levels of peak physical and mental performance through scientific well-being technologies will welcome, study, utilize, be grateful and celebrate this validated and documented advancements in the computer generated follow-up improvement programs, intervention protocols and the fun VR Games that are part of the quantifiable scientific well-being, optimal wellness, super-health and ideal fitness methods. In addition, smart people will appreciate the advanced major risk factor warnings, quantification, interpretation, early detection, correlation and tracking methods complete with VR Games, output reports, follow-up customized “Scientific Well-Being Programs,” the user-friendly summaries of present and impending hidden conditions and any health risk factors that normally go undetected until one suffers a serious disease or even worse a catastrophic meltdown or death.

These computer driven technologies take full advantage of recent progressive technologies and advancements that can actuarially determine and validate objective human total scientific well-being and other vital health measurements with small incrementally graduated ranking numerical scales based on the 10-Point Quantifiable Well-Being and Scientific Wellness Scaling and Factoring Formuli. The “10-Point Scales” are by far the most important aspects the invention. When compared to the escalating number of incurable and untreatable illnesses in the world (primarily a direct result of the medical industries' wide use of their own limited 2-Point Evaluation Scales, i.e., “Normal” or “Abnormal”), the present invention (which has no such side effects or ambiguous limitations) becomes even more valuable for the long-range future and survival of humanity.

The positive, fun VR Games (a significant embodiment of the present invention) provide the participant with one of the most powerful and safe, motivating educational experiences possible in this high-tech world of warfare oriented VR games (that are mainly focused on extremely negative killing and destroying activities, shooting skills, destructive choices and actions rather than any positive constructive, building, nurturing or loving actions and choices). The positive gaming feature of the present invention will set it apart from most of the “Destructive Killer-Rewarded Virtual Reality Games” currently popular and available in the lucrative world gaming markets. The positive impact potential that the present invention can have on future generations of many impressionable young minds and hearts is both exciting and awesome.

The present invention has the realistic potential of reprogramming many of the ugly, psychologically dangerous influences that the present negative-oriented VR games have on young, impressionable or mature minds to a much more positive mind set for a future sustainable environment and a healthier world. Many of the frequent prime time negative news stories that report on the modern scary destructive frightening actions and behaviors of crazed, dangerous and evil murders, killers, rapists, suicide bombers, terrorists, insane perpetrators of hideous crimes against others, may be psychologically linked to some of the wide spread use of these “killer” VR Games as a serious contributing factor to the increasing incidents of such crimes against humanity.

Numerous researchers are convinced that involvement in these dark, negative rewarding video games is a major contributing educational factor that provides the criminal viewer with many creative murderous ideas that can be directly correlated to the individual's exposure to and involvement in such destructive killer-oriented video and TV games and Internet Apps. The fact that the super-hero may be a good guy that is usually depicted as a valiant warrior and person trying to save the world becomes insignificant because even his creative and superior abilities to kill the targeted enemy have little redeeming value when one considers the consequences of exposing a sick devious criminal mind to any ingenious killer tactics that might be used by an evil terrorist against his or her perceived, real or imaginary enemies.

It is a most unfortunate, alarming and sad observation of the wide spread social illnesses in our war oriented world to realize that most of the biggest profits in these high-tech video games go to the popular geeks, developers and production companies of the most insidious “killer” video games on the market. Except for the increasing number of insane criminal terrorists and religious fanatics, there are very few global problems that can be realistically solved by more and more wars or better and more deadly weapons of mass destruction.

Additionally, the present invention also includes proven cost containment and risk reduction strategies that make it possible for employers to finally manage their worker health-care costs in a proactive way for those that are smart enough and/or self-insured entities who can appreciate the usefulness, intrinsic value and economic benefits of scientifically, actuarially and proactively utilizing the cross-correlated and weighted scores on each of the 10-Point Quantifiable Scientific Well-Being and Optimal Wellness Measurement Scales and Actuarially Validated Categories. Smart employers using these methods will finally be able to manage their most important assets, i.e., the personal and collaborative group geniuses of their key employees. In this manner, the global ethical key decision makers of the future will have new and improved ways to cope with life's many surprises and unprecedented challenges.

### BRIEF DESCRIPTION OF THE DRAWINGS

The present invention is described in greater detail in the following descriptions and examples embodying the specifications and best mode of the invention, taken in conjunction with the drawing figures, in which:

FIG. 1 is a block diagram illustrating the method by which combined sources of input data are analyzed by comprehensive comparative evaluation processes so that individualized and/or group output reports can be generated for the customized interventions which are one of the preferred forms of the invention;

FIG. 2 is a comprehensive schematic diagram showing the method according to the invention including the interconnections, comparative correlations resulting in specialized output reports that are utilized by the intervention programs plus customized data that generates VR Games unique to the individual participant, all of which are various aspects of the invention;

FIGS. 3A through 3E illustrate examples of important clinical measurements (usually taken by a well-being technician), such as: bio-physiological pulses, BMI, standard blood pressures, circulation cardio-efficiency and environmental pulmonary wellness measurements which indicate optimal wellness levels and any self-reported inherited genetic and/or medical risk-related conditions and/or risk factors (if any) which are some of the preferred embodiments of the invention;

FIGS. 4A through 4G illustrate examples of important subjective self-reported actuarially adjusted assessments of life purposes and missions, personal outlooks and core beliefs, lifestyle attitudes and habits, spiritual values, nutritional eating and drinking habits, movement and physical exercise behaviors, relationship and social wellness dynamics as well as other lifestyle indicators of well-being and ideal fitness as well as any inherited genetic and/or medical risk-related conditions and risk factors (if any) which are also some of the various preferred aspects of the invention;

FIGS. 5A through 5F illustrate examples of scientifically objective validated laboratory Biological and Physio-Chemically analyzed body fluids that are measured, evaluated and quantified by independent labs for determining optimal wellness levels combined with unique quantifiable well-being parameters, all of which are important embodiments of the present invention.

FIG. 6 is a fictional example of a single page summary report of an individualized Quantifiable Scientific Well-Being and Optimal Health and Fitness Summary Chart with simple, appropriately ranked personalized summaries and evaluations in the quantified categories and rankings according to the comprehensive 10-Point simple to understand graphically illustrated chart.

### DESCRIPTION OF THE PREFERRED EMBODIMENTS OF THE INVENTION

The preferred embodiments of this invention provide: (A) Quantifiable Scientific Well-Being, Optimal Wellness and Ideal Fitness Scales Evaluations, (B) Customized Interventions, and (C) Realistic Fun VR Games which result in actuarially more accurate tracking of changes of Super-Health, Quantifiable Scientific Well-Being, Optimal Wellness and Ideal Fitness Levels than ever before possible, plus superior prevention of catastrophic health crises by continuously comparing individuals against “Super Healthy Human Measurements” and correlating them to a series of “10” Point Scales. These Assessed Quantifiable Scientific Well-Being, Optimal Wellness and Ideal Fitness Scales are actuarially more accurate than any of the standard “Two (2)” Point Medical (“Normal/Abnormal”) Assessments, or any HRA Scales and/or the limited “Fit” or “Unfit” fitness evaluations. Consequently, individuals can now achieve much higher levels on the “Super-Health, Quantifiable Scientific Well-Being, Optimal Wellness and Ideal Fitness Scales” utilizing the intervention protocols and the custom self-educating VR Games which dramatize realistic consequences for lifestyle choices, through VR adventures and positive suggestions from the Game's brilliant Avatar. These VRs are specifically based on an individual's current measurements on the “10” Point Scales and serve to educate and motivate them on what choices and habits will create higher and higher “Scores” of Super-Health, Quantifiable Scientific Well-Being, Optimal Wellness and Ideal Fitness.

### Detailed Descriptions of the Drawings

The invention is further described in detail and pointed out with particularity in the appended claims. However, other advanced unique features of the invention will be best understood and appreciated by referring to the following detailed descriptions of the preferred drawing embodiments.

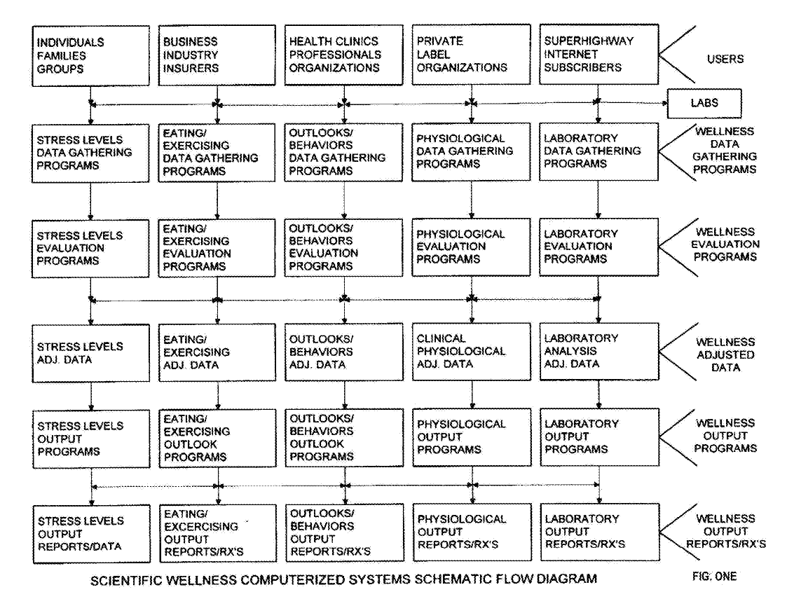

FIG. 1. is a graphic and comprehensive schematic diagram of the various input data sources, the internal computerized evaluations, comparisons, cross-correlated dynamics and components, the system and programs showing the interconnections and the unique comparative evaluative correlations between each category required by the more stringent quantifiable scientific well-being and measurable optimal wellness evaluations and tracking systems. In this FIG. 1 depiction, an embodiment of the invention has been chosen for the purpose of illustration only, the methods of preparing the more stringent Quantifiable Scientific Well-Being, Optimal Wellness and Ideal Fitness Assessments involves the integration and employment of many different data gathering sources, devices, apps, Internet downloads, forms, questionnaires, documents and sources of quantifiable super-health, scientific well-being, optimal wellness and ideal fitness information and any potential identifiable accident caused or inherited genetic and/or medical risk-related conditions and risk factors (if any) or data.

These contrasting correlations and comparisons begin with a pre-determined battery of lifestyle evaluations of certain technician administered bio-physiological pulses, body mass index (BMI), standard blood pressures, circulation cardio-efficiency and environmental pulmonary wellness measurements of scientifically measured technician administered clinical bio-physiological pulse, BMI, standard blood pressures, circulation cardio-efficiency and environmental pulmonary wellness measurements of scientifically measured optimal wellness levels and any inherited genetic and/or medical risk-related conditions and risk factors (if any), combined with unique and more stringent quantifiable well-being parameters, including customized lifestyle assessments of life purposes and missions, personal outlooks and core beliefs, lifestyle attitudes and habits, spiritual values, nutritional eating and drinking habits, movement and physical exercise behaviors, relationship wellness dynamics as well as other lifestyle indicators of scientifically measured and validated wellness and ideal fitness including any inherited genetic and/or medical risk-related conditions and risk factors (if any) combined with unique quantifiable, updated total well-being parameters, psychological behaviors and habits.

The subjective data from the updated and more stringent quantifiable scientific well-being parameters, including customized lifestyle assessments of life purposes and missions, personal outlooks and core beliefs, lifestyle attitudes and habits, spiritual values, nutritional eating and drinking habits, movement and physical exercise behaviors, relationship wellness dynamics as well as other lifestyle indicators and parameters can be collected from a series of data gathering phone apps, tablets, PCs, Internet connections, forms, devices and documents. This data is then combined with the more scientific objective measured data collected from a series of objective validated laboratory internal Biological and Physio-Chemically analyzed body fluids, including: Extremely Important Blood Lipid Chemistries, Total Endocrine Health and Well-Being, Vital Blood Glucose Wellness, Saliva, Excretory and Urine Wellness, Vital Hormonal Balance and Wellness, Immuno-Vitality, and Competency Health. This objective laboratory data carries the greatest importance in assessing any hidden factors as it is integrated and combined with the objective technician administered clinical bio-physiological pulses, body mass index (BMI), standard blood pressures, circulation cardio-efficiency as well as environmental pulmonary wellness and the more subjective self-reported customized lifestyle assessments.

The present invention can also accept, integrate, weight (if needed) and adjust verified information/data from special data gathering apps, programs and devices that have been designed for each major category to check the validity of the gathered data before it is transferred into the specific processing areas of the advanced evaluation and quantifying programs. In order to insure the most accurate and meaningful evaluations, correlations and comparisons, each of the data gathering sources, evaluations and quantification programs has been weighted and customized to check for validity in order to meet the special needs of objectively quantifying and analyzing the various types of data being processed. The evaluation and quantification software programs compare and contrast the gathered data with all the corresponding updated data areas as well as to the major evaluation and processing areas of the exclusive proprietary Super-Health, Quantifiable Scientific Well-Being, Optimal Wellness and Ideal Fitness Scales Data Bases.

Next, the evaluation programs process the data according to specific formuli and algorithms and then create an adjusted updated and weighted data output. The adjusted and weighted data outputs are fed to a series of customized output programs which generate special customized Output Reports that include: VR Game Scenarios, picturegraphic analyzes, improvement suggestions, specific intervention program recommendations on a multiple-page customized output App or a printout of individualized RXs for improving and/or maintaining specific quantifiable well-being and measurable scientific wellness ranking levels on the unique updated 10-Point Quantifiable Scientific Well-Being, Optimal Wellness and Ideal Fitness Scales.

The output follow-up programs, also may utilize a more stringent and advanced updated wellness data bank in which is stored a multiplicity of suggestions, RXs, recommendations and improvement protocols designed to fit as many comparative combinations as possible of the different circumstances which are likely to be made, referenced to by the gathered evaluated, adjusted and weighted quantifiable well-being and measurable scientific input data. Specific items of information can be highlighted in the participant's individualized Output Report so that each of the important quantifiable well-being and measurable scientific rankings are graphically and easily understood when combined with the participant's multiple-page scientific wellness output App or report with recommendations and summary, and at the same time relate personally to the participant's technician measured, “self-assessed” and objective laboratory analyzed data and information.

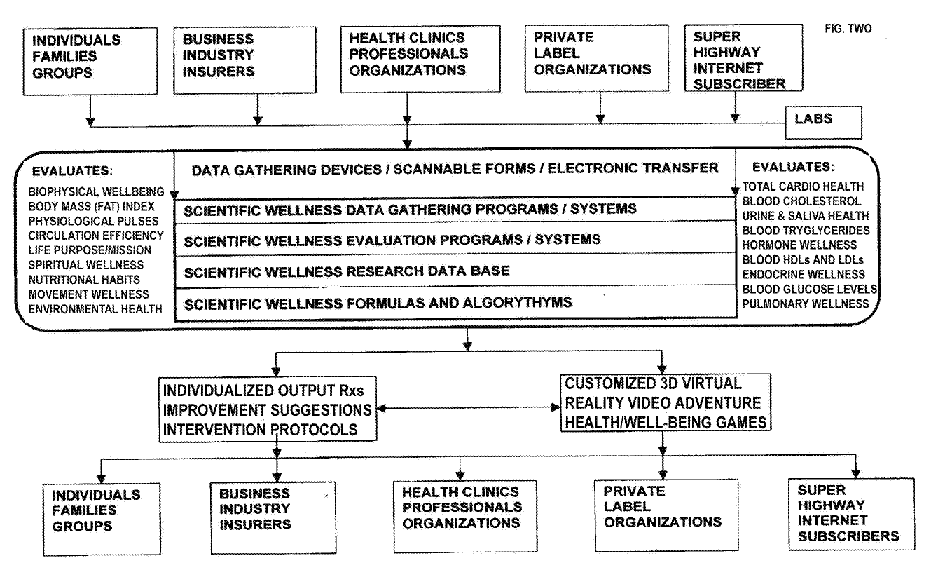

FIG. 2. shows a schematic block diagram illustrating the preferred embodiment of the sophisticated data processing, correlating software systems, Apps and programs incorporating many different data gathering devices, Apps, forms, questionnaires, documents and sources of both specific quantifiable well-being and measurable scientific wellness ranking levels and risk data. These may include some or all of the following: (1) actuarially objective cross-correlated bio-physiological tests and measurements that are scientifically measured and validated wellness and ideal fitness evaluations from various data gathering Apps, forms, devices, documents and sources, and recorded by uniquely trained and certified wellness technicians; (2) subjective cross-correlated self-reported assessments of quantifiable well-being parameters, plus the scientifically measured and validated wellness and ideal fitness evaluations as well as any inherited genetic and/or medical risk-related conditions and risk factors (if any) collected from a variety of data gathering Apps, Internet downloads, forms, devices, questionnaires, documents and sources; and, (3) the most accurate and objective scientific cross-correlated laboratory state-of-the-art quantifiable well-being parameters, plus the scientifically measured and validated wellness and ideal fitness laboratory evaluations as well as any inherited genetic and/or medical risk-related conditions and risk factors (if any) of internal quantifiable well-being parameters from a variety of data gathering Apps, Internet downloads, forms, devices, documents and sources entered and/or merged with laboratory electronic data transfers into the Quantifiable Well-Being and Scientific Optimal Wellness Database System.

All of the Quantifiable Scientific Well-Being, Optimal Wellness and Ideal Fitness data is compiled; checked for validity; stored as an inventory of quantifiable well-being and total wellness, super-health, ideal fitness and risk-related information and knowledge; and, then evaluated, analyzed and compared to the quantifiable well-being and optimal wellness databases. The software systems and programs are capable of rapid data input of quantifiable well-being, objective wellness and laboratory data entry and processing. The individualized output, quantifiable scientific well-being and optimal wellness reports contain a series of visual depictions each having analysis information categorized on the 10-Point Quantifiable Scientific Well-Being, Optimal Wellness and Ideal Fitness Scales as well as highlighted suggestions, recommendations and improvement protocols that are graphically portrayed and can either be sent to a computer, tablet or phone App, printed on compatible printers or downloaded for processing by a high-speed computerized printing service company. Collecting the most accurate, validated and verifiable quantifiable well-being data has demonstrated itself to be of surprising importance, because it often determines whether the participant will make any positive behavior or habit changes to improve their achievable levels of measured quantifiable scientific well-being, optimal wellness, super-health and ideal fitness levels and/or reduce any inherited genetic and/or medical risk-related conditions and risk factors (if any).

### Quantifiable Well-Being and Scientific Wellness have 3 Important Major Areas

The “Quantifiable Scientific Well-Being, Optimal Wellness and Ideal Fitness Scales Parameters” for the 10-Point Scales fall into three major areas which can be tested, correlated, evaluated and updated “actuarially, scientifically and objectively.” These Three (3) Major Quantifiable Scientific Well-Being, Optimal Wellness and Ideal Fitness Areas provide sufficiently accurate, objective and believable ranking or rating information to assist smart individuals in making optimally healthy informed decisions in all the important areas of Quantifiable Scientific Well-Being, Optimal Wellness and Ideal Fitness choices.

The First group is 10-Point “Wellness Technician Measured” and updated quantifiable “Bio-Physiological Well-Being Parameters” of Super-Health and Ideal Fitness Levels, which include: “bio-physical pulse wellness, body mass (FAT) index, circulation cardio-efficiency, environmental pulmonary wellness, and cardio-diastolic and systolic well-being.” The assessments of these measured categories are based on the validated quantifiable scientific well-being, optimal wellness and ideal fitness scales in a special database as well as any genetic and/or medical risk-related conditions and risk factors (if any) of associated data.

The Second more subjective set is comprised of 10-Point “Self-Assessed” Quantifiable Scientific Well-Being, Optimal Wellness and Ideal Fitness Parameters that is self-reported data on “lifestyle, mission, spiritual well-being, attitudes, outlooks, habits and usual behaviors, nutritional and exercise habits, nurturing relationship wellness and commitment to well-being.”

The Third group of Categories and Parameters are certain more accurate and objective “Laboratory Analyzed, Hidden Inside, Measurements of Comprehensive Biological and Physio-Chemistry Laboratory Tests and Evaluations” of validated correlated body fluids, which are even more stringent physiological and biochemical laboratory analyzed data categories as quantifiable parameters comprising: “extremely important blood lipid chemistries, total endocrine health and well-being, vital blood glucose wellness, saliva, excretory and urine wellness, vital hormonal balance and wellness, and immuno-vitality and competency health.

Together, these Parameters comprise the “Three (3) Cross-Correlated Major Groups, Categories and Parameters objectively quantifies a person's present level of Super-Health, Quantifiable Scientific Well-Being, Optimal Wellness and Ideal Fitness” as well as any inherited genetic and/or medical risk-related conditions and risk factors (if any). In addition, these Three (3) Categories also actuarially evaluate one's present and potential future of major and minor “Health Risk Factors” and serve as early predictors and/or indicators of the earliest possible means of detection of any hidden or potential serious symptoms, sicknesses and/or diseases.

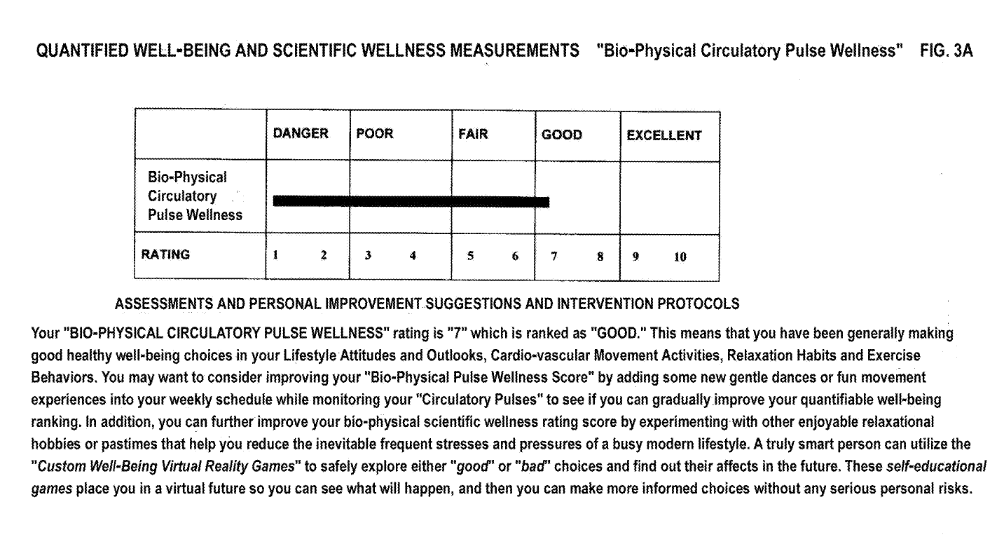

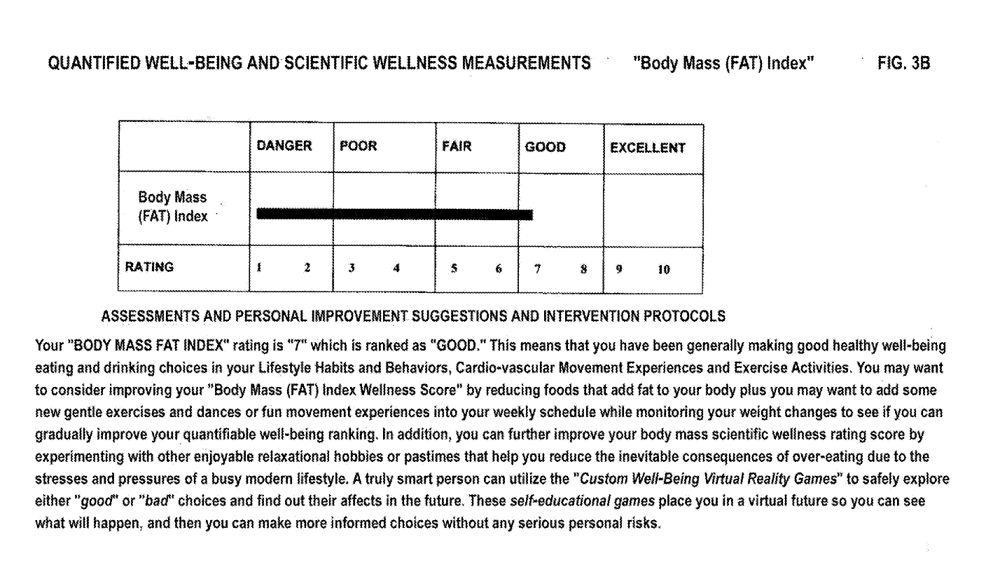

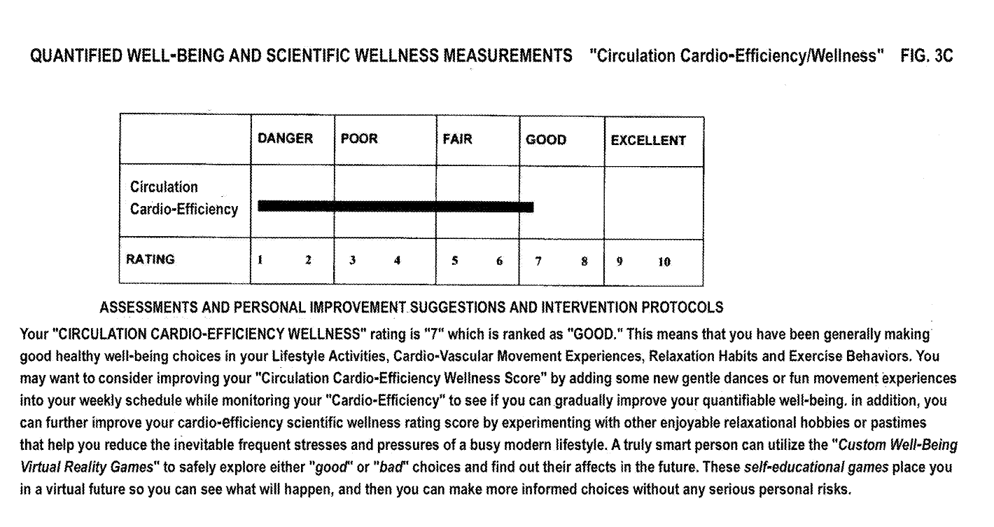

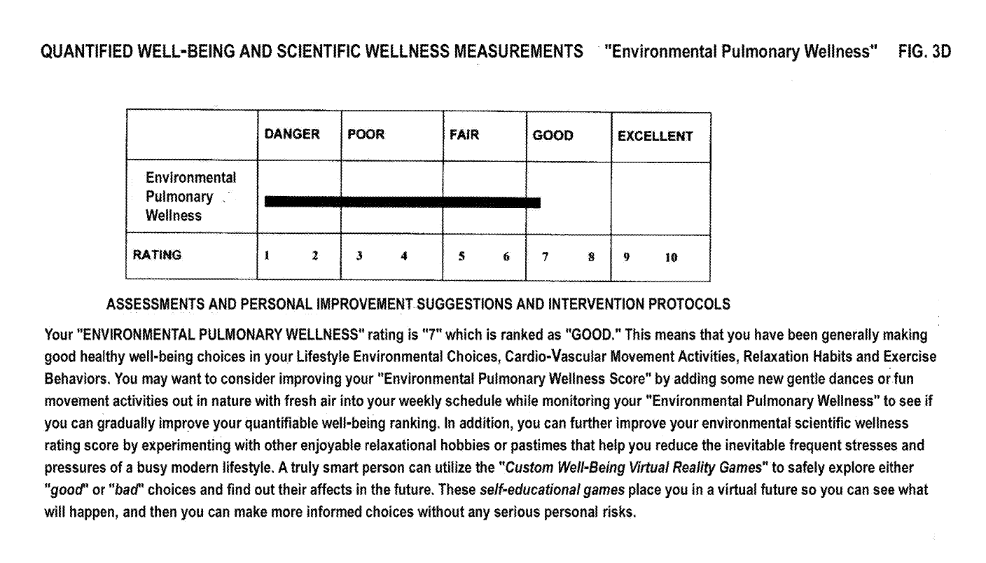

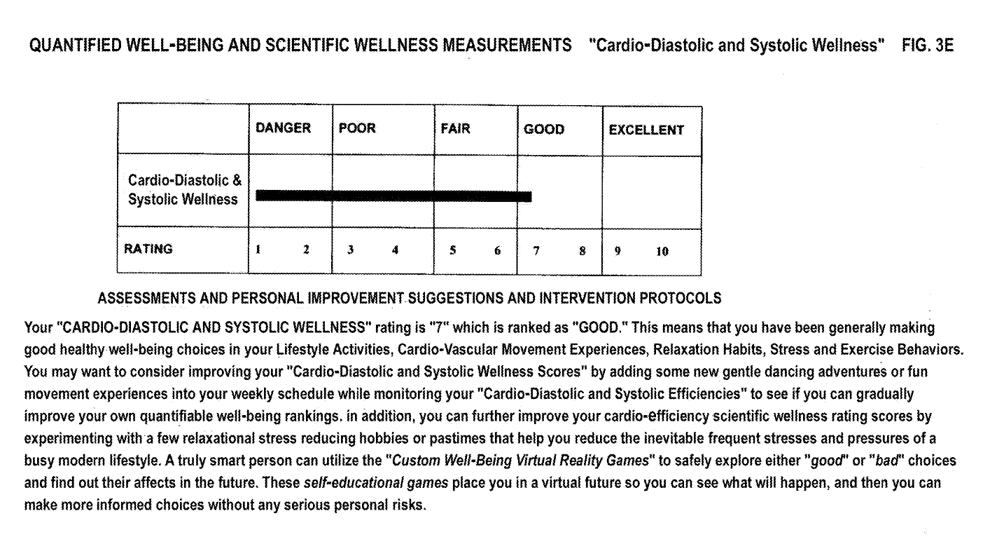

### FIGS. 3A-3E: Bio-Physiological Clinical Measurements of Well-Being

Of equal and perhaps greater importance than all the “Self-Reporting Parameters” herein (with the exception of an “Important Life Purpose/Mission”), are the major important, objective wellness technician assessed Bio-Physiological Well-Being measurements for simply and accurately measuring a person's level of validated quantifiable scientific well-being, optimal wellness and ideal fitness as well as any genetic and/or medical risk-related conditions and risk factors (if any). Fortunately, these Bio-Physiological Well-Being tests are designed so that no one can cheat on them. A few people seem to be able to mentally focus and thus lower their systolic cardiovascular measurement and/or their sedentary pulses.

However, most people, even trained athletes, cannot usually maintain a lower number on these tests while being evaluated by a well-being technician. Thus, these Bio-Physiological Well-Being Parameters usually provide a reasonable, accurate Quantifiable Scientific Well-Being, Super-Health, Optimal Wellness and Ideal Fitness Evaluation as well as being a good indicator of any Genetic inherited and/or Medical Risk-Related Conditions and Risk Factors (if any). This objectivity is not true of the following self-reported “lifestyle, mission, spiritual well-being, attitudes, outlooks, habits and usual behaviors, nutritional and exercise habits, nurturing relationship wellness and commitment to well-being parameters” which are highly dependent upon a person's memory, truthfulness and/or accuracy of remembering details, self-perception and responding to the assessment questionnaire, whether it is on a smart phone App, on a touch screen computer, on a form or questionnaire or document to be filled out. But almost no one can quickly change or cheat on the technician measurements of these Bio-Physiological Well-Being Parameters, so this type of evaluation can generally be an empirically accurate quantifier of measured quantifiable “Bio-Physiological Well-Being” parameters.

### These Bio-Physiological Tests Assure Greater Accuracy of Other Parameters

The most encouraging aspect of these state-of-the-art objective tests (i.e., the Bio-Physiological Well-Being measurements) is that all of them have been carefully cross-correlated over the last three plus decades of scientific research to the entire panel of the Bio-Physiological Well-Being Parameters. In the process of evaluating such cross-correlations for actuarial statistical significance, an interesting phenomenon was discovered. When a person entered data on a kiosk or computer or filled out a form, questionnaire or document and/or told a technician about their attitudes, outlooks, commitment to wellness, and eating habits, how often they exercised or how vigorously they exercised, their use of substances, etc.; the accuracy of their responses was magically increased to near perfect truth, especially when that person knew that their Bio-PhysioLabChemistry Well-Being Parameters (cholesterol, HDL, LDL, triglycerides or glucose) would also be measured in the near future. This generally was also true of a body fat measurement by a technician, or a stress temperature dot circulation efficiency assessment was going to be taken by a technician within 48 hours. When the individual knew such measurements were pending, they usually became extremely honest, told the bottom line truth (even if damaging to their fantasy health image) on what their “lifestyle, mission, spiritual well-being, attitudes, outlooks, habits and usual behaviors, nutritional and exercise habits, nurturing relationship wellness and commitment to optimal well-being” were and the truth about whether or not they consistently had some form of exercise, with what intensity, how regular and how much. This was not generally the case if the person responded to the data gathered in verbal assessments, answered the request for information on a computer, or filled out the data needed on a kiosk, or on forms, devices, questionnaires or documents without knowing that the additional objective evaluations would be involved in the assessment process.

### No One Can Cheat on These Objective Bio-Physiological Measurements

Regularly utilizing these “Bio-Physiological Well-Being Parameters” is probably the most important part of accurately measuring a person's level of Super-Health, Quantifiable Scientific Well-Being, Optimal Wellness and Ideal Fitness as well as any inherited genetic and/or medical risk-related conditions and risk factors (if any), because almost nobody can successfully “cheat” on these measurements. Most people can't cheat or alter their objective blood pressure assessments, or their Bio-Physical Circulatory Pulse Wellness, stress temperatures, or how fat they are. Because of this, these simple objective lifestyle habits and attitudes guarantee a much greater accuracy on the Quantifiable Well-Being, Scientific Optimal Wellness and Ideal Fitness of both the psychological and the lifestyle Parameters (habits) than was ever achievable before these important cross-correlations were discovered, documented, verified and validated.

This means that the Bio-Physiological Well-Being tests and measurements are some of the “most important” Parameters for measuring Super-Health, Quantifiable Scientific Well-Being, Optimal Wellness and Ideal Fitness, viz., Bio-Physiological Circulatory Pulse Wellness, Body Mass (FAT) Index, Circulation Cardio-Efficiency, Environmental Pulmonary Wellness, as well as Cardio-Diastolic and Systolic Well-Being which includes the resting and exercise heart rates, the recovery heart rates, the oxygen utilization, the blood pressure measurements, the body fat composition (the percentage of fat to muscle), the circulation efficiency stress temperature measurement (especially at the extremities), the height and weight ratio, the type of frame, urine and saliva (sputum) analyses, blood cell analyses, the vital capacity pulmonary function and the forced expiratory volume (for smokers or vapors).

### Objective Bio-Physiological Tests are Useful for Monitoring Total Well-Being

These Bio-Physiological Well-Being Parameters tests and measurements are usually objective. Saliva is produced from glands in the mouth and is an indicator of the health and wellness of the person. All of these Bio-Physiological Parameters are ranked on a scale from “One” to “Ten.” The combination of these tests and measurements objectively determine a person's true level of Quantifiable Well-Being and Scientific Wellness. Fortunately, these objective measurements can be repeated periodically to determine any small incremental positive “desirable” or negative “unwanted” changes. In this manner, smart people who are committed to quantifying and tracking their own vital improvement(s) now have a user-friendly method that is the embodiment of the present invention that takes the guesswork out of making informed choices as s/he decides to go for higher levels of Quantifiable Scientific Well-Being, Optimal Wellness and Ideal Fitness.

### FIG. 3A. Bio-Physiological Circulatory Pulse Wellness

FIG. 3A. is a reproduction of the individualized and personal Bio-Physiological Scientific Well-Being, Optimal Wellness and Ideal Fitness multicolor visual depictions and analysis information showing the participant's ranking on this 10-Point Parameter categorized and depicted as the “Bio-Physiological Circulatory Pulse Wellness Rating” combined with the highlighted suggestions and recommendations that are correlated to empirically measured and quantified specific evaluations and 10-Point Bio-Physiological Scientific Well-Being, Optimal Wellness and Ideal Fitness Scale.

It is best if the different heart rates of the Bio-Physiological Circulatory Pulse Wellness Rating Scale are measured in order to determine the relative beats per minute, or the number of times per minute that the heart makes a contraction and pumps blood through the arteries of the cardiovascular system. There are three (3) types of these Bio-Physiological Circulatory Pulse Scientific Well-Being, Optimal Wellness and Ideal Fitness Ratings (i.e., resting, exercise, and recovery) that can be measured. The “resting rate” is the most important number to assess, because that is the number of pulses per minute when a person is actually sedentary or lying down. The sedentary pulse or resting heart rate often indicates a person's level of overall total-body cardiovascular efficiency and stress levels.

### Resting Beats Per Minute May Show One's Level of Well-Being

The number of beats per minute in a “resting heart rate” will give an indication of the person's level of optimal Bio-Physiological Circulatory Pulse Scientific Well-Being. It will also may be a good indicator of their level of stamina and healthy conditioning. It may be important to also know the “exercise heart rate.” This is often adjusted based on an individual's age, involvement in physical activities and level of conditioning. If a person is really in good physiological shape, then s/he can raise that exercise heart rate to a higher endurance level than one who has not exercised in many years but is willing to begin exercising. There is an appropriate ultimate target percentage for the “exercise heart rate” (which is generally 80%) that is commonly used as the ideal target rate for everyone whether currently involved in either an improvement program or in a maintenance program based on their level of exercise ability and their present age.

Well-being researchers and certified trained technicians have looked with a great deal of interest at the speed (number of minutes or longer) with which a person being evaluated reaches their “exercise heart rate” and then returns to the resting rate after that person has been exercising vigorously for a pre-determined length of time (usually 15 to 20 minutes). This is called a “recovery heart rate.” It indicates the internal, hidden scientific well-being, optimal wellness and ideal fitness level of the person being measured, and how fast the cardiovascular system and the heart are able to return back to the “resting pulse rate” after vigorous exercise. Because the resting pulse is ultimately affected by the average exercise and recovery heart rates, it is the primary, personal Bio-Physiological Scientific Well-Being, Optimal Wellness and Ideal Fitness measurement that is generally measured and tracked to indicate the efficiency of the entire cardiovascular system.

### FIG. 3B. Body Mass (Fat) Index or Percentage is more Important than Weight

FIG. 3B. is a reproduction of the individualized and personal Bio-Physiological Scientific Well-Being, Optimal Wellness and Ideal Fitness multicolor visual depictions and analysis information showing the participant's ranking on this 10-Point Parameter categorized as the “Bio-Physiological Scientific Well-Being, Optimal Wellness and Ideal Fitness” combined with the highlighted suggestions and recommendations that are correlated to this specific Body Mass (FAT) Index summary evaluation on the 10-Point Bio-Physiological Scientific Well-Being, Optimal Wellness and Ideal Fitness Rating.

Due to the ever-increasing abusive eating habits of many people, the next really important measurement is the Body Mass (FAT) Index. This is a measurement where a certified well-being technician actually measures the percentage of Body Mass (FAT) Index in the body right under the skin. This is best done (for accuracy) by a trained and certified well-being technician with high-quality calipers. This measurement, if done by a highly qualified technician will generally get as close as 97% accuracy on subcutaneous fat measurements. It is probably one of the fastest and easiest bio-physiological scientific well-being, optimal wellness and ideal fitness measurements. It will also indicate any genetic and/or medical risk-related conditions and risk factors (if any). There is one other validated measuring system that is more accurate (other than with the calipers) which can be done to measure this body mass (fat) index or composition. It is the hydrostatic or underwater weighing, and is considered to be the most accurate, but it also takes the most time and may be costly.

Measuring Body Mass (FAT) Index is very important in terms of total wellness because this is an indicator of the level of Bio-Physiological Scientific Well-Being, Optimal Wellness and Ideal Fitness throughout the entire body. It is a measurement to determine the amount of fat in the body. The higher the FAT, the less likely an individual will have a long and fulfilling life and the greater the chances of various disorders usually related to obesity and to other serious health problems. Body Mass (FAT) Index is an extremely important measurement because it measures the relationship and percentage of fat to muscle ratio in the tissues throughout the body.

Continued research has shown that weight alone is not as significant as the ratio of muscle to body fat. The ideal Body Mass (FAT) Index is quite different for women than for men. Well-being ideals are based on many years of research and testing many thousands of people to determine their ideal Body Mass (FAT) Index. For men, it is around 9-11%; but for women, it is between 15-22%. Super-Healthy Women need more body cushioning and fat than men, because it is necessary for proper functioning of the delicate balances of their intriguing hormonal systems. These optimal percentages are based on many years of research and are used for determining not only a person's ideal weight but many other conditions that can prevent most sicknesses and diseases and give a much higher quality of life to the individual.

Body Mass (FAT) Index serves another “psychological type of purpose” for some people since the obese person may be able to believe that as they add more body fat it becomes an insulator to keep them from actually feeling things in their life or it may serve to avoid sexual harassment and keep others at a social distance. For this reason, psychologically speaking, the Body Mass (FAT) Index measurement is a good indicator of a person's level of fear of intimacy or closeness as well as an indicator of their perceived need for protection.

### Height and Weight Ratio, an Alternative Body Mass Index Approximation

These specific Body Mass (FAT) Index and Wellness summary measurements ultimately determine a person's height and weight ratio. Calculating this may provide a simple, user friendly easy approximate measurement of Body Mass (FAT) Index, if wellness trained and certified technicians are not available for accurate assessments of this important “Bio-Physiological Well-Being” parameter. However, the calculation of a person's ideal height to weight ratio is only an approximation and may need to be adjusted for different types of body frames, such as: small, medium or large bones and body sizes.

### FIG. 3C. Circulation Cardio-Efficiency/Wellness, a Stress Dot Temperature Test

FIG. 3C. is a reproduction of the individualized and personal Bio-Physiological Scientific Well-Being, Optimal Wellness and Ideal Fitness multicolor visual depictions and analysis information showing the participant's ranking on this 10-Point Parameter categorized as Circulation Cardio-Efficiency and Total Wellness.

The Circulation Cardio-Efficiency Assessment Parameter depicts how healthy one's circulatory system is internally and out to the end of the fingers. This Circulation Cardio-Efficiency and Total Wellness measurement utilizes a stress dot temperature test at the extremities. This Circulation Cardio-Efficiency and Total Wellness may include things like cold feet, cold hands, or other circulatory indicators of how efficient a person's circulation may be at this moment. The Circulation Cardio-Efficiency and Total Wellness is one way to measure how good a person's cardiovascular system is functioning to circulate the blood all the way out to the tiniest capillaries.

This Circulation Cardio-Efficiency and Total Wellness measurement is another important Bio-Physiological Scientific Well-Being, Optimal Wellness and Ideal Fitness Measurement. It generally indicates the tension levels and any cardio blockages within one's body and how “chronic” or how tight certain muscle groups may be in the arms or legs, as well as whether or not a person can relax sufficiently and let go; and if so, how fast and how extensive throughout the body. This category correlates to this summary evaluation on the 10-Point Bio-Physiological Scientific Well-Being, Optimal Wellness and Ideal Fitness Scale.

### FIG. 3D. Environmental Pulmonary Wellness and Cardio-Respiratory Efficiency

FIG. 3D. is a reproduction of the individualized and personal Bio-Physiological Scientific Well-Being, Optimal Wellness and Ideal Fitness multicolor visual depictions and analysis information showing the participant's ranking on this 10-Point Parameter categorized as the “Environmental Pulmonary Wellness” combined with the highlighted suggestions and recommendations that are correlated to this empirical summary evaluation of the 10-Point Bio-Physiological Scientific Well-Being, Optimal Wellness and Ideal Fitness Scale.

### Lung Vital Capacity/Forced Volume Evaluation

Evaluations of a person's Lung Vital Capacity/Forced Volume Tests provide added important information, especially for individuals that work or live in very smoggy or polluted areas or have smoked excessively in the past (but quit) or for those that are still smoking or living with a smoker/vaper. The assessment of this Parameter is generally optional for non-smokers or for those who work or live in non-smoggy areas. But for individuals who are smoking or exposed to heavy smoke, smog or other toxic air conditions, these need to be evaluated and tracked. The “Environmental Pulmonary Wellness Score” measured as the vital capacity and forced volume of the lungs is an important indicator of the Bio-Physiological Scientific Well-Being, Optimal Wellness and Ideal Fitness of the person. Monitoring this Parameter will indicate still another measurement of a person's level of Bio-Physiological Scientific Well-Being, Optimal Wellness and Ideal Fitness. This category correlates to this specific summary evaluation on the 10-Point Bio-Physiological Scientific Well-Being, Optimal Wellness and Ideal Fitness Scale.

### Smoking/Air or Water Pollution Environmental Wellness Habits

As part of the scientific evaluation of the updated and improved “Environmental Pulmonary Wellness Assessment Parameters,” it is important to evaluate a person's smoking/vaping habits and/or exposure to cigarette/cigar/pipe/vaping and/or other toxic smoke, including secondary smoke by being around smoke, and/or any water pollution environmental conditions. The purity of both air and water are very important causative factors that can seriously affect achieving and maintaining Bio-Physiological Scientific Well-Being, Optimal Wellness and Ideal Fitness on the 10-Point Scales. Actuarially, these environmental factors are not as important as the scientifically objective laboratory evaluations or the basic self-reported “lifestyle, mission, spiritual well-being, attitudes, outlooks, habits and usual behaviors, nutritional and exercise habits, nurturing relationship wellness and commitment to well-being parameters” which are highly dependent upon a person's memory, but they are still important enough that they must be considered on the 10-Point Bio-Physiological Scientific Well-Being, Optimal Wellness and Ideal Fitness Scales.

### FIG. 3E. Cardio-Diastolic and Systolic Well-Being Scale

FIG. 3E. is a reproduction of the individualized and personal Bio-Physiological Scientific Well-Being, Optimal Wellness and Ideal Fitness Scale multicolor visual depictions information showing the participant's ranking on the 10-Point Quantifiable Parameters categorized as Bio-Physiological Well-Being and Scientific Wellness which combines both the standard Diastolic and Systolic Blood Pressure Measurements which are then ranked as the “Cardio-Diastolic and Systolic Well-Being Score” combined with the highlighted suggestions and recommendations that are correlated to this specific summary evaluation on this important 10-Point Bio-Physiological Well-Being Scale.

### Quantifiable Scientific Well-Being and Optimal Wellness Blood Pressure(s) Tests

The Cardio-Diastolic and Systolic Well-Being Evaluations are among the most common tests and measurements used by the medical and illness industries. There are many places in urban communities where a person can sit down in a store with a device for such a quick test. These tests can be important evaluators of the Bio-Physiological Well-Being and Scientific Wellness Parameters, because they are also indicators of the internal efficiency of the entire cardiovascular system, including any blockages and/or circulatory efficiencies. In these traditionally sphygmomanometer blood pressure measurements, two different Parameters, both the diastolic and systolic pressures are measured and tested.

Caution is suggested here for obtaining accurate readings on these important scientifically objective Bio-Physiological Well-Being and Scientific Wellness Measurements and Parameters, for a variety of important reasons. First and most important, almost all of the recent modern electronic high-tech (hands free) devices used to measure blood pressures (even the most recent ones that are commonly used by the illness professionals in hospitals, medical clinics and doctor's offices) generally are potentially about 20% off the correct traditional sphygmomanometer readings. Secondly, even if a medically trained person uses the hand-held blood pressure cuff which can be closer to the traditional sphygmomanometer readings; they are frequently much too poorly trained to get any accurate wellness or fitness measurements; because they tend to be in a hurry and are trained to only look for gross approximations that might indicate a serious symptom or diseased condition. Thirdly, the newest devices in the retail stores (markets, pharmacies, etc.) may also be generally about 20% off the correct readings.

Finally, the best source for an accurate and true diastolic and systolic pressure measurements is a certified well-being technician or professional using a blood pressure cuff or the older traditional sphygmomanometer device which is capable of getting the most accurate measurements, if administered by an adequately trained medical technician or professional. Most of the blood pressure tests administered in many clinics, hospitals and doctor's offices are inaccurate and tend to be only approximate blood pressure measurements. As such, they are of little value for getting accurate blood pressure numbers or readings needed for either baseline or small incremental changes in the internal blood pressures (positive or negative) which can be posted on the Cardio-Diastolic and Systolic Well-Being Scale.

### The Non-Situational Cardio-Diastolic Blood Pressure Measurement

The Diastolic measurement is not as situational as the Systolic. The Secondary Cardio-Diastolic Number (which is the pressure measurement within the entire cardiovascular system and the heart, including all of the arteries and veins when the heart is between cycles and not pumping), is generally determined by a number of factors. Some of these causative Cardio-Diastolic factors include: (a) hypertension, (b) overall stress, (c) the buildup of cholesterol in the blood vessels, (d) arterial sclerotic conditions in the arteries or in the heart itself, (e) the efficiency and stamina of the heart muscle itself, or (f) any other complicating factors in terms of the complete internal cardiovascular system.

All of these Cardio-Diastolic factors affect the Cardio-Diastolic Well-Being Measurements; so it is the most important measurement in terms of achievable levels ranked on the Cardio-Diastolic and Systolic Well-Being Scales. The Cardio-Diastolic Well-Being Measurement is not very situational, yet it qualifies as the best indicator for revealing the total efficiency of the entire cardiovascular system. The Cardio-Diastolic is primarily determined by the tested person's level of health, fitness and wellness. When well-being scientists and technicians evaluate risk levels represented in the blood pressure measurement(s), they consider both the second number, the Cardio-Diastolic Number (the in between internal at rest measurement of pressure) as well as the Cardio-Systolic Score (the pressure measurement). Thus, it is the Cardio-Diastolic Score that quantifies how a person has really been living their life and the lifestyle habits and choices which they have developed over time.

### The Situational Systolic Blood Pressure Measurement

The Cardio-Systolic Blood Pressure Score, however, can be very situational. A person can travel on a freeway the wrong way or have some major stress or have something happen suddenly to frighten them, and their Cardio-Systolic Score will go up noticeably. It can be dramatically affected temporarily by a variety of frightening or stressful circumstances. The Cardio-Systolic Score is the pressure that is measured when the heart is contracting and pumping blood throughout the entire cardiovascular system, and it is the first and highest number when a blood pressure reading is taken by a technician. SPECIAL NOTE: A high Cardio-Systolic Score alone may not be an indicator of high-risk. If high, pay more attention to the Cardio-Diastolic Score.

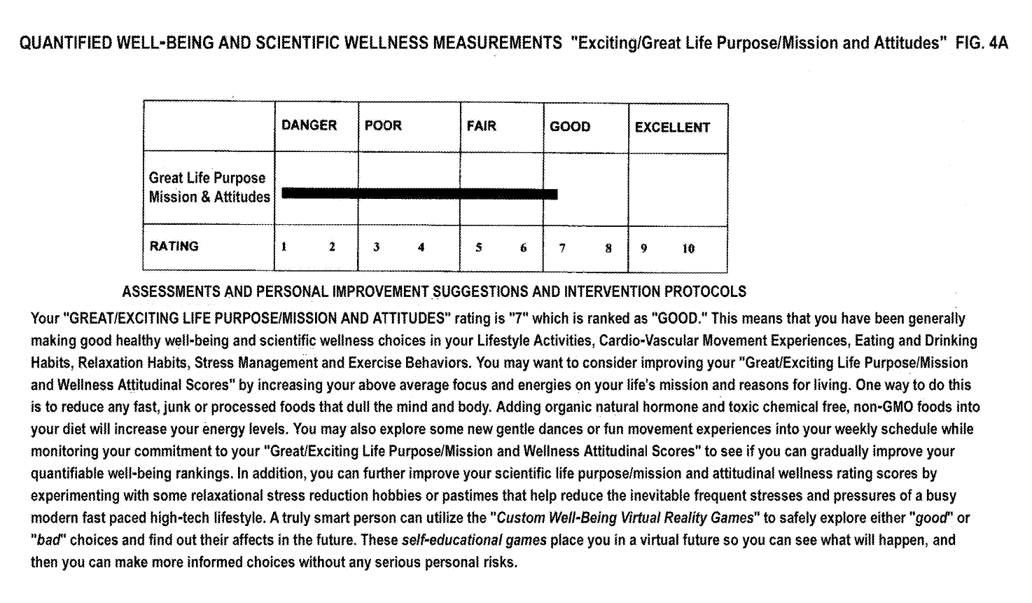

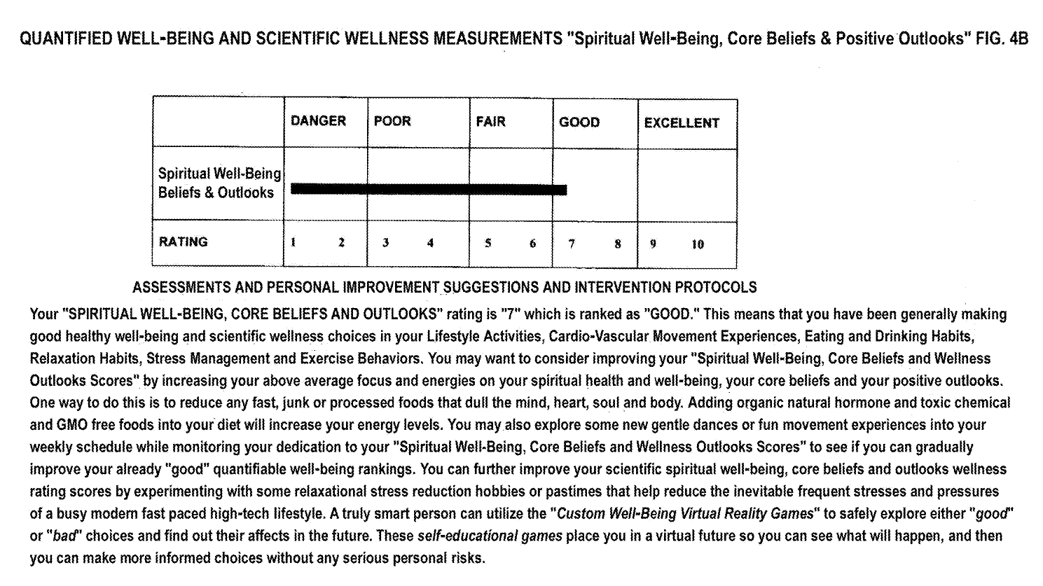

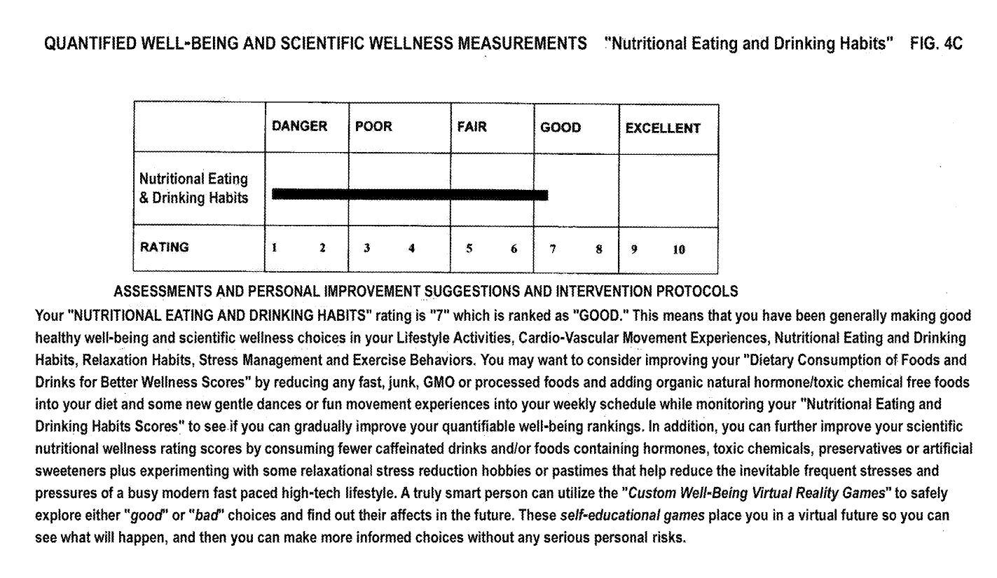

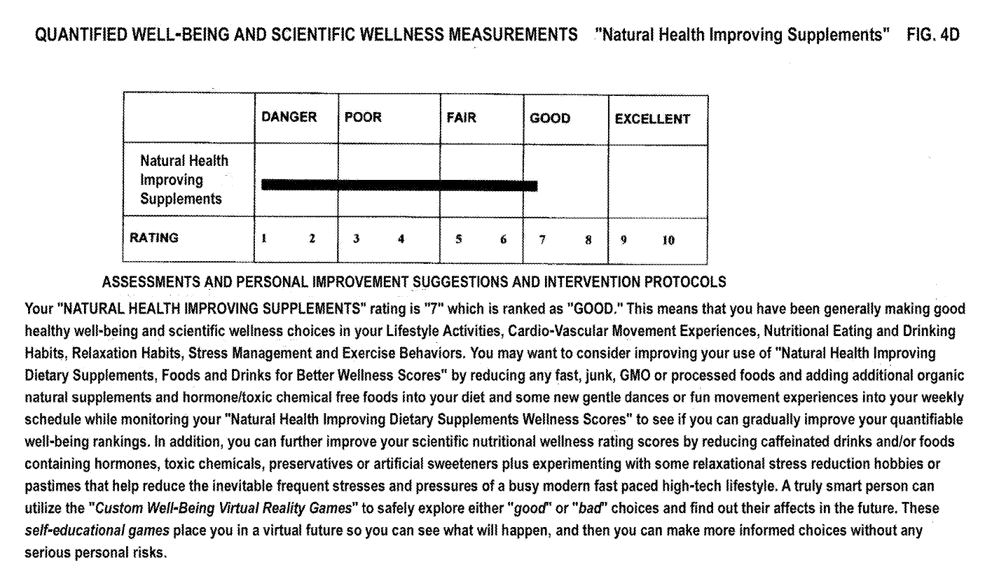

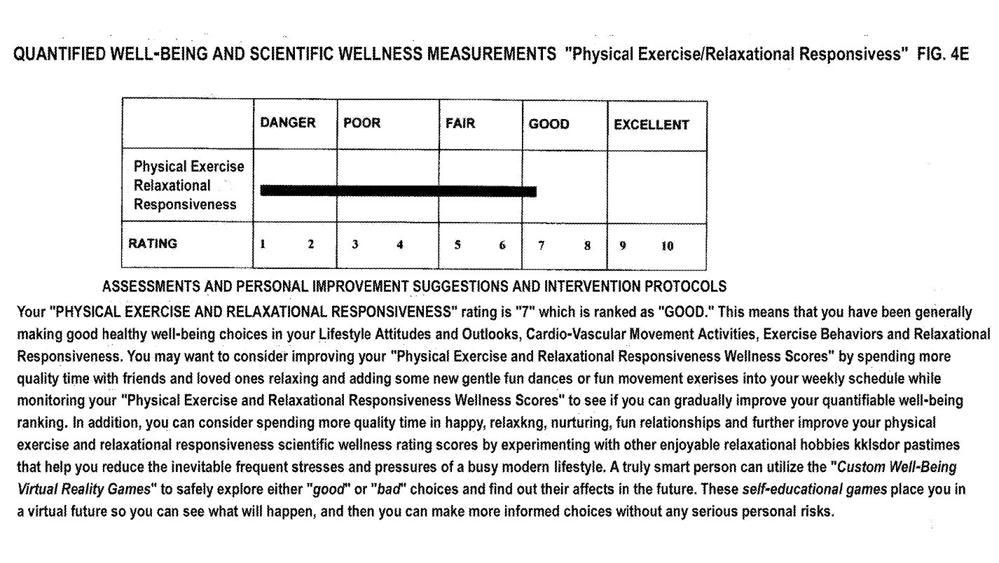

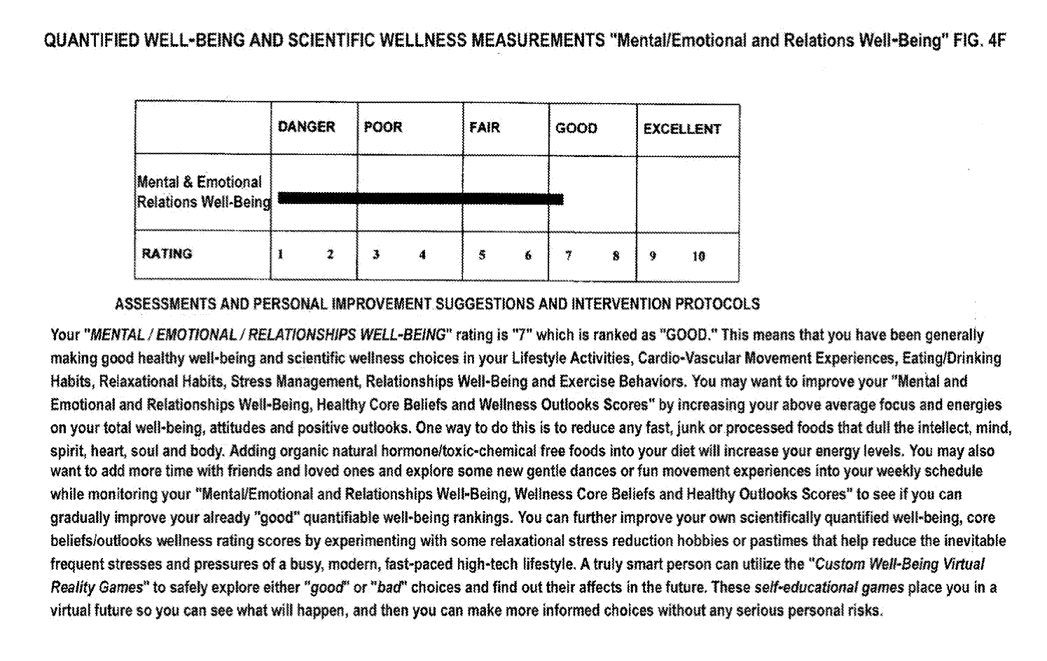

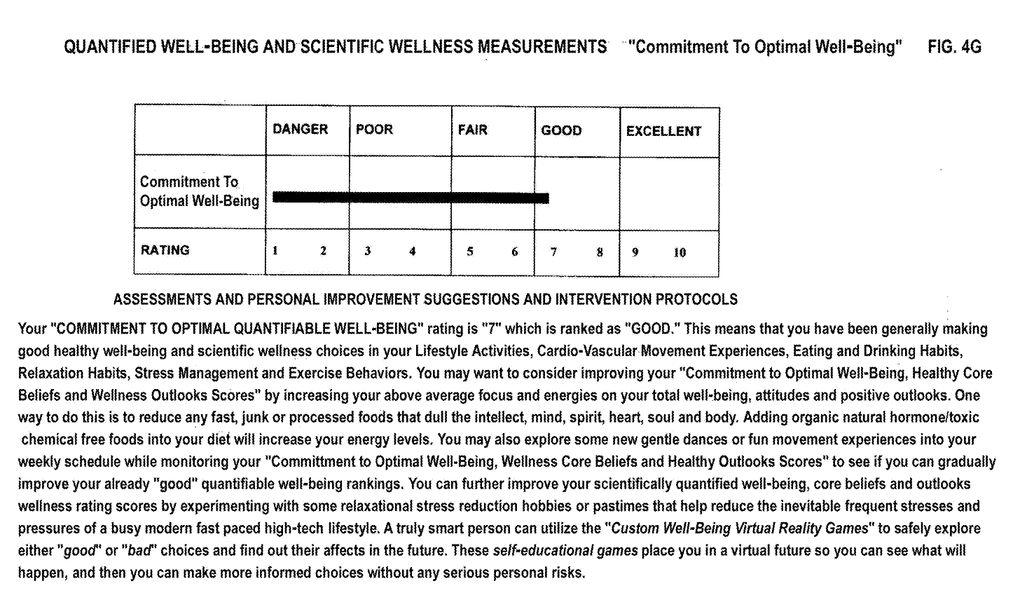

### FIGS. 4A-4F: The Self-Reported and Self-Assessed Great Exciting Life Purpose and Mission, Well-Being Attitudes, Nutrition Eating/Drinking Habits, Physical Exercise, Fun Nurturing Relationships, Mental and Emotional Well-Being and Commitment to Optimal Scientific Wellness and Self-Love Categories

The “Self-Reported and Self-Assessed Life Purpose/Mission, Well-Being Attitudes, Nutrition, Exercise, Nurturing Relationships, Quantifiable Mental and Emotional Well-Being and Commitment to Optimal Scientific Wellness Parameters” of Super-Health, Quantifiable Scientific Well-Being, Optimal Wellness and Ideal Fitness include subjective Self-Reported and Self-Assessed Categories that seriously support or limit a person's achievable levels of super-health, quantifiable scientific well-being, optimal wellness and ideal fitness. Since these categories are determined by an individual's personal Self-Reported and Self-Assessed information and data collection, the special parameters of Super-Health, Quantifiable Scientific Well-Being, Optimal Wellness and Ideal Fitness associated with these areas are highly dependent upon a person's integrity, motivations, memory, truthfulness, accuracy of remembering details, self-perception, self-denial and one's ability to accurately respond to the customized lifestyle attitudes and behaviors assessment questions honestly. Actuarially, these categories are often weighted or adjusted according to some of the more objective biological and physiological data available on the individual.

However, because of their significance and unprecedented importance in determining all achievable levels of Super-Health, Quantifiable Scientific Well-Being, Optimal Wellness and Ideal Fitness, their assessment is vital to the overall scheme of being able to accurately assess Super-Health, Quantifiable Scientific Well-Being, Optimal Wellness and Ideal Fitness Levels.

### FIG. 4A. Exciting Great Life-Purpose/Mission and Well-Being Attitudes

FIG. 4A. is a reproduction of the individualized and personal Super-Health, Quantifiable Scientific Well-Being, Optimal Wellness and Ideal Fitness multicolor visual depictions and analysis information showing the participant's ranking on the subjective aspects of the 10-Point Quantifiable Parameters categorized as the “Self-Reported and Self-Assessed Exciting Great Life Purpose/Mission and Well-Being Attitudes” combined with the highlighted suggestions, recommendations and improvement protocols that are correlated to the summary evaluations of the “Self-Assessed” 10-Point Super-Health, Quantifiable Scientific Well-Being, Optimal Wellness and Ideal Fitness Scales.

This particular category of assessment has quantifiably become the most important category of measurement to determine a person's present and future levels of achievable and maintainable Super-Health, Quantifiable Scientific Well-Being, Optimal Wellness and Ideal Fitness Ratings. In spite of the inherent limitations and flaws associated with collecting Self-Reported and Self-Assessed Personal Information and Data, the Life Purpose/Mission and Attitudinal Category continues to remain at the very top of the list of evaluative and predictive information categories or data parameters that ultimately determine a person's achievable levels of super-health, quantifiable scientific well-being, optimal wellness and ideal fitness.

As surprising as this may seem to materialistic people, this area of assessment continues to rank as the most important and accurate single category with the greatest determining success of predicting short and long-term future outcomes from dedicated participants who wish to maximize their chances of healthy aging and potential longevity. Over the last three plus decades of on-going research, the statistics related to this category being the most important of all areas of assessment keeps repeating itself.

The reasons for these surprising phenomena are relatively simple. If an individual has a high level of passion and excitement for a truly exciting life purpose and mission, they will eagerly arise each day to magically overcome any challenges and difficulties in order to complete or fulfill their life purpose and mission. Each day brings much happiness, joy and fulfillment, plus many intangible and tangible rewards. However, people who do not know or have a life purpose or mission have no reason to continue living in this stressful dimension, and often retire to boring or frustrating lifestyles at senior communities where they live in deep mental and emotional pain hoping today could be their last. Because their boring or pain ridden lives have little or no excitement, they constantly wish for death as soon as possible.

Each year, the research continues to re-affirm that this category of assessment is by far the most difficult and yet the most important of any Super-Health, Quantifiable Scientific Well-Being, Optimal Wellness and Ideal Fitness categories, even more accurate and valuable than the scientifically assessed laboratory measurements. The assessment of “basic attitudes, outlooks and behaviors” continue to rank as one of the highest on all of the 10-Point Bio-Physiological Well-Being and Scientific Wellness Rating Scales as the areas that are foundational to all of the other vital “Parameters of Super-Health, Quantifiable Scientific Well-Being, Optimal Wellness and Ideal Fitness.” These have repeatedly turned out to be the most significant and important Parameters statistically, because out of all of the important Well-Being Parameters, this one affects all of one's lifestyle choices/habits as it becomes the bottom line where behaviors are determined, every last one of them, in fact, from what one does when s/he gets up in the morning to what s/he does before s/he finally retires at night and goes to bed for rejuvenating rest or sleep.

### FIG. 4B. Spiritual Well-Being, Core Beliefs and Positive Outlooks

FIG. 4B. is a reproduction of the individualized and personal Super-Health, Quantifiable Scientific Well-Being, Optimal Wellness and Ideal Fitness multicolor visual depictions and analysis information showing the participant's ranking on the subjective aspects of the 10-Point Parameters depicted as the “Self-Reported and Self-Assessed Spiritual Well-Being, Core Beliefs and Positive Wellness Outlooks” that is combined with the highlighted suggestions and recommendations that are correlated to this ranking on the “Self-Assessed” 10-Point Super-Health, Quantifiable Scientific Well-Being, Optimal Wellness and Ideal Fitness Scales.

This category ranks “second” in importance to the previous Life Purpose and Mission area of measurement in determining a participant's present and future levels of achievable and maintainable Super-Health, Quantifiable Scientific Well-Being, Optimal Wellness and Ideal Fitness. The Life Purpose/Mission and Attitudinal Category plus the Spiritual Well-Being combined with Loving Core Beliefs and Well-Being Outlooks Parameters continue to remain at the highest level of significance and importance near the very top of the list of evaluative and predictive information or data parameters that ultimately determine a person's realistic and achievable levels of Super-Health, Quantifiable Scientific Well-Being, Optimal Wellness and Ideal Fitness.

While many dummies are often completely “Self-Serving or Self-Absorbed” and totally “Focused” on “What Do I Really Want!” or “It's All About ME,” the truly advanced smarter and “Super-Healthy Person” has become aware of the bigger picture, knowing, connecting and communicating with greater and wiser pure loving Spirits that provide nurturing energy throughout the universe to aware and loving beings. While living in this dimension, it is very wise to be committed to becoming spiritually well with dynamic choices of Loving Core Beliefs and Positive Outlooks.

### FIG. 4C. Nutritional Eating and Drinking Habits

FIG. 4C. is a reproduction of the individualized and personal Super-Health, Optimal Wellness, Quantifiable Well-Being and Ideal Fitness multicolor visual depictions and analysis information showing the participant's ranking on subjective aspects of the 10-Point Parameters categorized as the “Self-Reported and Self-Assessed Nutritional Eating and Drinking Habits” that is combined with the highlighted suggestions and recommendations that are correlated to this specific updated and improved summary and ranking on the “Self-Reported and Self-Assessed” 10-Point Super-Health, Quantifiable Scientific Well-Being, Optimal Wellness and Ideal Fitness Scales.”

Throughout the world, most ethical optimal health and medical researchers, professionals and practitioners of numerous health care modalities, consider nutritional eating and drinking habits to be the most important predictor of potential Super-Health, Quantifiable Scientific Well-Being, Optimal Wellness and Ideal Fitness. However, the numerous people involved in the decades of actuarially based well-being research have discovered additional information and data that statistically lessens the importance of this category of achievable scientific well-being and optimal wellness in contrast and comparison to one's Life Purpose/Mission, Attitudinal, Spiritual Well Being, Healthy Core Beliefs, and Positive Outlooks. Even though it is true that a person ultimately becomes what s/he eats and drinks, there are many challenging modern factors that complicate this ancient axiom.

Ethical scientific nutrition researchers still recommend consuming mostly natural organic (non-GMO) home prepared optimally nutritious foods and drinks instead of frequent restaurant cooked meals (i.e., seriously avoiding foods that have been processed, or contain a long list of toxic chemicals/preservatives, including any with GMO/MSG ingredients, or residues of hormones, pesticides, artificial sweeteners, etc.), so a person can be sure of the purest natural qualities of the ingredients. Continued (hidden agenda free) research has found out that most if not all of the highly processed, fast and junk foods contain many unnatural toxic ingredients and additives that ultimately lead to many modern illnesses, such as: obesity, endocrine and cardiovascular disorders, autism, cancers, hypertension, diabetes, chronic digestive illnesses, emotional and mental diseases, adrenal disorders, brain dysfunction, to name just a few.

However, optimally natural and healthy nutrition continue to be vitally important in achieving and/or maintaining a functional body and mind, a healthy vital and competent immune system plus achieving and maintaining Super-Health, Quantifiable Scientific Well-Being, Optimal Wellness and Ideal Fitness. This is because these natural high quality nutritional foods provide the building blocks for super-health, quantifiable scientific well-being, optimal wellness, ideal fitness and sustainable super-healthy longevity.

Another increasingly important dietary ingredient that is becoming more critical every day is the purity or dangerous pathogens and toxic substances of potable drinking and cooking water. Today, many urban and rural sources of potable tap water are often too extremely dangerous to drink due to toxic ingredients, chemical spills, pesticides, fracking and other blatant contamination of both ground and under-ground waters.

Actuarially, the nutrition and diet supplement Parameters are quite important ones because they are foundational categories for understanding what foods, drinks and natural supplements are serving as valuable replacement ingredients to keep the body and mental cells hydrated, healthy, vibrant and functioning optimally. If utilized wisely, the tests and tracking aspects of this invention can help many intelligent people determine the ideal quantities of fat needed in a person's ideal customized diet, the optimal amounts of cholesterol sources of nutritionally healthy food types needed to keep the cardiovascular system in super-healthy condition, as well as the amount of natural healthy salts and sweeteners (raw but not artificial) sugar/honeys and other ingredients which can either bring a person to optimal health and wellness or cause them potential sickness and serious diseases or other complications. This is the smartest way to utilize these objective scientific evaluations to personalize one's dietary nutritional needs to easily determine the best diet for each person's unique DNA, inherited genetics, metabolism, endocrine wellness, physiology and environmental and/or any substance sensitivities.

### FIG. 4D. Natural Health Improving Supplements

FIG. 4D. is a reproduction of the individualized and personal Super-Health, Quantifiable Scientific Well-Being, Optimal Wellness and Ideal Fitness multicolor visual depictions and analysis information showing the participant's ranking on subjective aspects of the 10-Point Quantifiable Parameters categorized as the “Self-Reported and Self-Assessed Natural Health Improving Supplements” that is combined with the highlighted suggestions and recommendations that are correlated to this specific summary and ranking on the “Self-Assessed” 10-Point Quantifiable Scientific Well-Being and Optimal Wellness Scales.”

In the not too distant past, most of the health and longevity dedicated people in the world did not need dietary supplements to “Stay Well.” But that ideal world of yesterday is gone. Today's health minded person is facing: (a) constant pandemic conditions, even in public settings, (b) rapid increases in the total number of deadly medicine (MRSA) resistant super-bugs, (c) an ever-growing list of numerous toxic environmental problems (such as mold), (d) a huge list of toxic disease and cancer causing substances (with some new secret artificial sweeteners [cleverly called natural flavors] that the FDA does not require being listed on labels as an ingredient, even in organic foods and drinks), and, (e) an increasing group of giant industries profiting from prescriptive medicines and minimal treatment of symptoms in preventable illnesses. However, such an idyllic, safe, balanced sustainable eco-friendly, green non-toxic environment or world is difficult, if not impossible to find. Consequently, many people who are committed to quantifiable scientific well-being and optimal wellness have found it both wise and necessary to carefully research the ethical values and strategies of companies distributing high quality natural food based supplements, since there can be an ever-increasing number of unsafe, hidden or dangerous toxic ingredients not listed on the ingredients.

This supplemental nutritional area of need and concern is uniquely addressed in the Super-Health, Quantifiable Scientific Well-Being, Optimal Wellness and Ideal Fitness Programs by providing frequently updated informational links for smart people who want to know what they are consuming and who is profiting from their consumption of foods and drinks. Passionate people participating in the quantification, assessing, measuring, evaluating, comparing and correlating of the many integrated parameters of super-health, quantifiable scientific well-being, optimal wellness and ideal fitness will bless the day they found out about how to monitor and track all of the vital and important Super-Health, Quantifiable Scientific Well-Being, Optimal Wellness and Ideal Fitness Parameters that provide accurate, easy to understand valuable data and information with links and resources not available from any one source or health professional in the self-serving supplement businesses or the dishonest entities in the illness and food industries.

Smart people who truly care about their sustainable futures will welcome the sophisticated small incremental changes that can be measured and tracked on up to more than 40 validated Super-Health, Quantifiable Scientific Well-Being, Optimal Wellness and Ideal Fitness related categories that are based on decades of ethical private research in helping people determine the best diet for each person's unique DNA, inherited genetic weaknesses and challenges, metabolism differences, endocrine wellness, environmental and/or substance sensitivities (including residual outgassing of pesticide treatments, new carpet glues and building materials, nuclear and EMF radiation concerns, microwave signals and other emerging problems) as well as any bio-physiological distinctive reactions that may have not yet been adequately researched.

This category has become extremely important as the nutritional quality, hidden toxic ingredients and the natural purity of the foods consumed has dramatically deteriorated in many mass produced and processed super-market foods and produce. This challenge is causing more and more smart people to have increasing and legitimate health concerns. In some cases, these foods and drinks contain so many toxic ingredients that they should be banned as disease causing items. Sound healthy natural organic foods from ethical farms that are high in nutritional content supported by natural healthy dietary supplements and natural foods (non-processed or fast foods) can provide most people with the important ingredients needed for achieving and/or maintaining super-health, quantifiable scientific well-being, optimal wellness and ideal fitness, especially if a person takes repeated advantage of the scientific evaluations and objective information gleaned from the analysis of physiological tests and measurements combined with specialized laboratory data on important body chemistries and fluids.

### FIG. 4E. Physical Exercise and Relaxational Responsiveness

FIG. 4E. is a reproduction of the individualized and personal Super-Health, Quantifiable Scientific Well-Being, Optimal Wellness and Ideal Fitness multicolor visual depictions and analysis information showing the participant's ranking on subjective aspects of the 10-Point Quantifiable Parameters categorized as the “Self-Reported and Self-Assessed Gentle Cardiovascular Movements and Physical Exercise Activities that are combined with the highlighted suggestions and recommendations that are correlated to this ranking on the “Self-Assessed” 10-Point Regular Gentle Non-Stressful Movement and Physical Exercises, Fun Movement Activities Scales and Natural Relaxational Responsiveness.”

After decades of scientific research on the importance of fun, gentle non-stressful physical movement and cardio exercise activities, the “Self-Assessed” 10-Point Gentle Non-Stressful Movement, Physical Exercises and Fun Movement Activities Category contains important cardiovascular exercise guidelines that will help anyone wanting to achieve and maintain Super-Health, Quantifiable Scientific Well-Being, Optimal Wellness and Ideal Fitness. Strenuous vigorous high performance physical activities can be over rated and abused by greedy sports and fitness industries. Many peak performing athletes, Olympic Gold Medalists and marathon winners generally sacrifice healthy-aging and longevity in order to achieve their super human goals.

Then there are the tales, for example, of the reclusive longevity societies of native indigenous peoples in several parts of the world that have learned how to get healthier and more relaxed while effortlessly improving their running or moving abilities as a person ages. Just the opposite story is true in most urbanized parts of the modern world. In these longevity societies, the “50” year-olds can move and run for many miles longer than the “30” year-olds. But the “70” year-olds have downsized and perfected their movement stressors to the point that they can out run and perform better than the younger “50” year-olds. As they continue to age they get healthier. However, the “70” year-olds cannot keep up or last as long as the “90” and hundred year-olds who have been known to run up to 100 miles without stopping for a rest period. The point of all this indigenous tribal news is that for increased longevity, a person must only include gentle, only slightly aerobic non-stressful movement and exercise that increases cardiovascular efficiency and flexibility.

This total body movement category is often the most neglected part of the modern sedentary lifestyles, especially in achievable levels of Super-Health, Quantifiable Scientific Well-Being, Optimal Wellness and Ideal Fitness, due to people frequently using their vehicles, skate boards or bicycles to go short distances rather than walking. Additionally, most people in our modern society live a very sedentary lifestyle (watching TV or playing video games for many hours per week), including sitting on the job more than moving around.

Consequently, many people have a need for adding fun gentle movement or exercise into their daily and weekly lifestyles because they are not very active. Watching the changes in the ranking numbers on the Self-Assessed” 10-Point Regular Gentle Non-Stressful Movement and Physical Exercises and Fun Movement Activities Category can aid each person in finding enjoyable movement activities that lower resting heart rates, improve levels of stamina and lower Cardio-Diastolic Blood Pressure Scores where an ideal target pulse rate would be to get the sedentary heart rate below 50 pulses per minute.

Since high levels of stress are often the results or consequences of numerous modern lifestyle economic choices, the embodiments of this invention can become a simple “self-improvement tool” with ever increasingly stringent validated quantifiable rankings of Super-Health, Quantifiable Scientific Well-Being, Optimal Wellness and Ideal Fitness including any genetic and/or medical risk-related conditions and poor health factors (if any) that can be safely changed by experimenting and testing various intervention protocols to discover what improvement programs work the best to create the most positive changes in the Super-Health, Quantifiable Scientific Well-Being, Optimal Wellness and Ideal Fitness Scales.

At the present time, there is no known objective system of determining total inner hidden levels of stress. However, an evaluation of key types of stressors and risks in a person's life can be very important. Even though stress still has a lot of unknown and hidden components and factors, its effects will still dramatically correlate to certain quantifiable physiological and laboratory tested Parameters of quantifiable scientific well-being, optimal wellness and ideal fitness.

Stress may affect many important assessed lifestyle scientific well-being and optimal wellness factors, such as: stress tested temperatures, mental and emotional well-being and optimal wellness, both systolic and diastolic blood pressures, (resting, exercise, recovery heart beats per minute) pulse rates, BMI, digestion and eating habits, commitment to well-being and wellness, endocrine well-being and wellness, hormone balances, immuno-vitality, liver and adrenal functions, and especially one's blood lipids. High levels of stress can also affect and/or change some of the internal physiological numbers, including: major blood lipids, immunocompetency of white blood cells, etc.

### FIG. 4F. Mental/Emotional/Nurturing Relation Well-Being

FIG. 4F. is a reproduction of the individualized and personal Super-Health, Quantifiable Scientific Well-Being, Optimal Wellness and Ideal Fitness multicolor visual depictions and analysis information showing the participant's ranking on subjective aspects of the 10-Point Quantifiable Parameters categorized as the “Self-Reported and Self-Assessed Mental and Emotional Well-Being, Optimal Health and Nurturing Relationships Well-Being Category” that is combined with the highlighted suggestions and recommendations that are correlated to this specific updated and improved summary and ranking on the “Self-Assessed” 10-Point Mental/Emotional Optimal Health and Nurturing Relationships Well-Being Scales.”

This category includes a combination of intellectual, emotional, and mental factors. These are often the most elusive factors to quantify and frequently the most difficult to assess or evaluate from an accurate scientific perspective. The reason for this is that there are no actuarially standardized optimal tests or evaluations, instruments, methods, systems or devices to determine what are the most reasonable, acceptable, socially proper, appropriate, and/or “healthy” feelings or emotions. Generally, the professionals in the counseling fields of medical psychiatry, therapeutic psychology or marriage and family therapy as educationally oriented counselors feel or believe that “any emotion” is proper, so long as it is a true emotion and not a contrived, attention seeking, manipulative, cover up or psychodrama emotion. But this untested theory or opinion of many counseling professionals is flawed because it has never been tested to any objective or ideal degree. Most of the psychometric devices used have been normed on mentally ill people.

All too often in the present highly stressed pressures of the fast-paced lifestyles of the current economically challenged modern society (whether one lives in a polluted urban small or large city or in a slightly less toxic rural environment), nurturing relationships often get lost, replaced or sacrificed by survival issues and challenges. Regardless of the family, work or social setting, it is often nearly impossible to find any one or more persons that exemplifies a truly exciting, fun, loving and nurturing relationship. Even the most popular TV shows, soap operas and most movies are seriously deficient in healthy examples of nurturing relationships. More often than not, these media channels attempt to capitalize on abusive relationships in order to improve their ratings and popularity. Why is there such a paucity and lack of famous exemplary heroes of ideal truly loving social bonding couples or groups? Too often, the only answer to this query is that no one cares enough to commit to the time it takes to create and nurture any super-healthy, loving, nurturing relationships.

The modern lifestyle often exemplifies the self-serving attitude: “It's all about ME.” Another contributing factor is the reality that most people have very little training or information of how to develop, foster and maintain a nurturing relationship. Thus, a person generally depends on pure but rare blind luck in the hopes that some kind of divine fortune will mysteriously happen (like winning the lottery) that connects them magically to one or more persons capable of choosing, contributing to and maintaining a dream type of ongoing truly exciting, fun, happy, loving and nurturing relationships that will make positive contributions to their optimal mental and emotional balances.

Since everyone's internal emotional terrain is frequently and sometimes silently (mysteriously) affected by highly charged, dramatic, painful and/or sad feelings (whether the feelings have been unconsciously self-generated or reactively created in response to a drama orchestrated or initiated by another, such as: provoked or unprovoked angry/hostile outbursts of others), one's “Personal Emotional “IQ” and Self-Developed Nurturing Relationship's Quotient” will largely be determined by one's choices and how a super-healthy person is able to cope with and/or diffuse the highly charged immediate situation. It is interesting that the popular “Emotional IQ Programs” were not based on super-emotionally healthy individuals. Instead, they were developed, tested and normed or validated on only average dysfunctional people.

This is where the value of the present invention skyrockets. By taking full advantage of the measuring and improvement suggestions and customized information provided through the “Validated Quantifiable Scientific Well-Being and Optimal Wellness Scales, the Intervention Programs and the customized VR Games,” a smart individual can self-educate themselves by experimentation utilizing the various intervention protocols to create new and improved ways to cope with life's many relationship's disappointments, surprises and unprecedented challenges.

### FIG. 4G. Commitment to Optimal Well-Being

FIG. 4G. is a reproduction of the individualized and personal Super-Health, Quantifiable Scientific Well-Being, Optimal Wellness and Ideal Fitness multicolor visual depictions and analysis information showing the participant's ranking on subjective aspects of the 10-Point Quantifiable Parameters categorized as the “Self-Reported and Self-Assessed Commitment to Super-Health, Quantifiable Scientific Well-Being, Optimal Wellness and Ideal Fitness that is combined with the highlighted suggestions and recommendations that are correlated to this specific updated summary and ranking on the “Self-Assessed” 10-Point Commitment to Optimal Well-Being Scales.”

In order to consistently improve a person's personal 10-Point Super-Health, Quantifiable Scientific Well-Being, Optimal Wellness and Ideal Fitness Parameters and achieve one's dreams of becoming a super-healthy peak performing human being, that individual will need to continually monitor and evaluate their personal commitment to Super-Health, Quantifiable Scientific Well-Being, Optimal Wellness and Ideal Fitness. As a motivated person moves towards their ideal well-being goals, they may become surprised at the number of excuses that will magically appear in their mind to sabotage their dedication and commitment to the challenging task of improving any of their personal Super-Health, Quantifiable Scientific Well-Being, Optimal Wellness and Ideal Fitness Goals.

They may also be shocked at the many “negative” friends and some family who will repeatedly attempt to influence them to cheat on their list of things to avoid that can increase their risks and lower their Quantifiable Super-Health, Quantifiable Scientific Well-Being, Optimal Wellness and Ideal Fitness Rankings. Then there are the powerful media ads on screens and signs everywhere attempting to sell them their high-energy super-processed foods and drinks so they can feel socially acceptable in a society full of dumb, ignorant, uninformed addicts, who have little or no concern about their own future Quantifiable Super-Health, Quantifiable Scientific Well-Being, Optimal Wellness and Ideal Fitness Rankings.

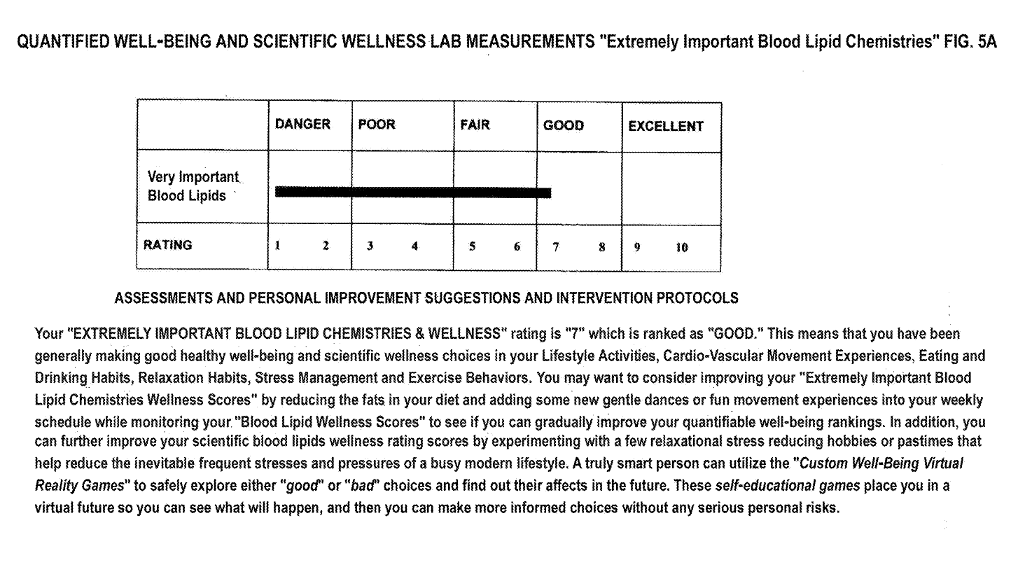

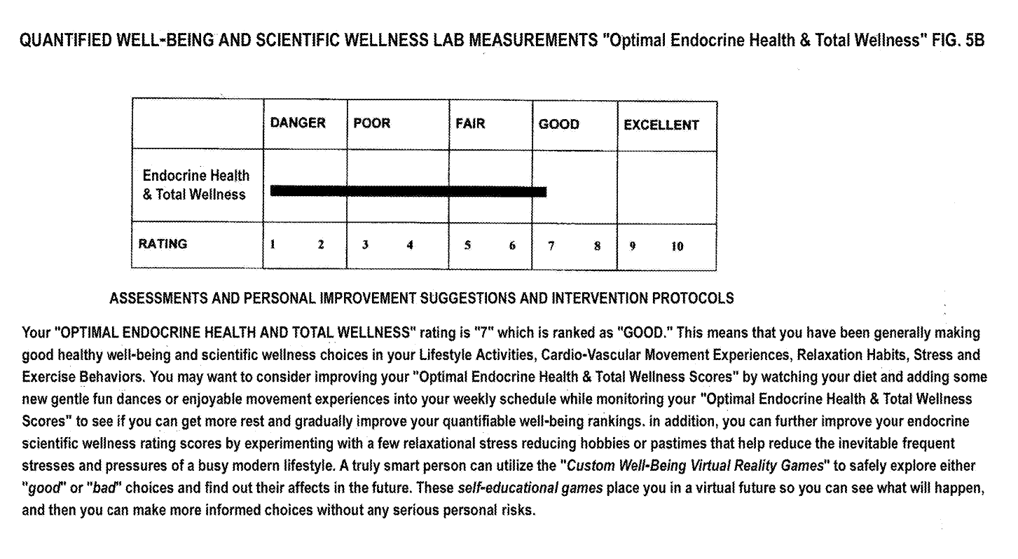

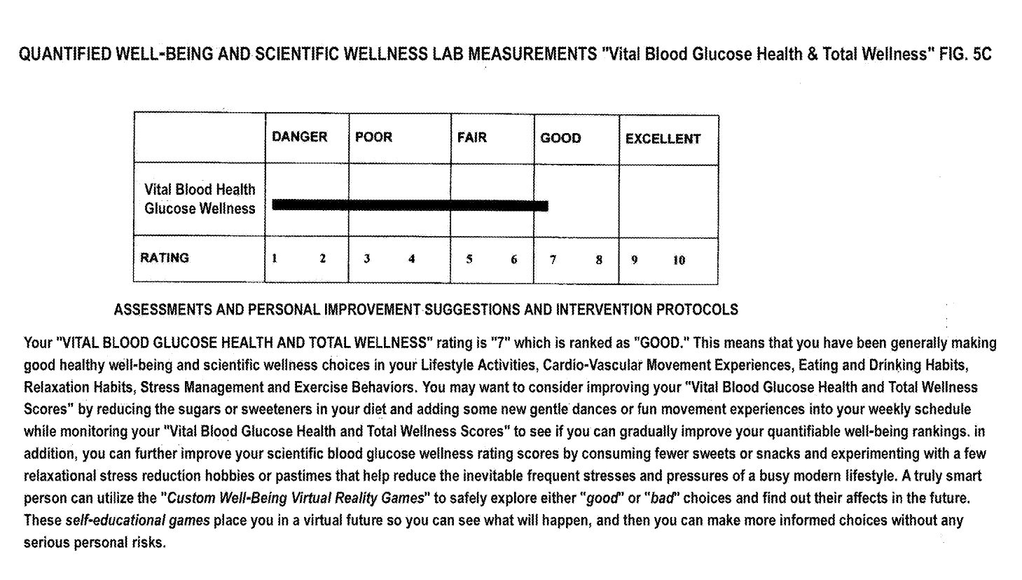

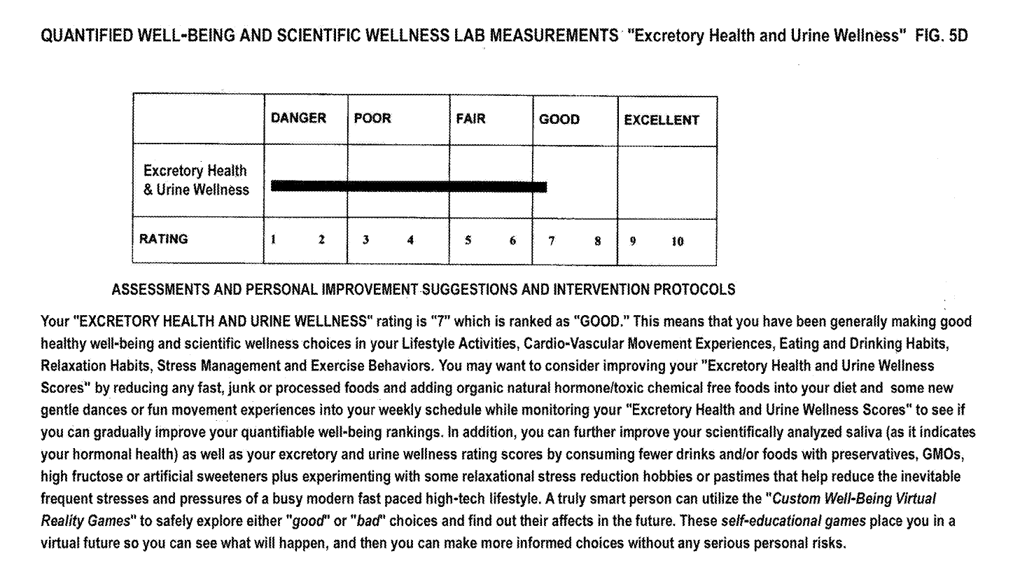

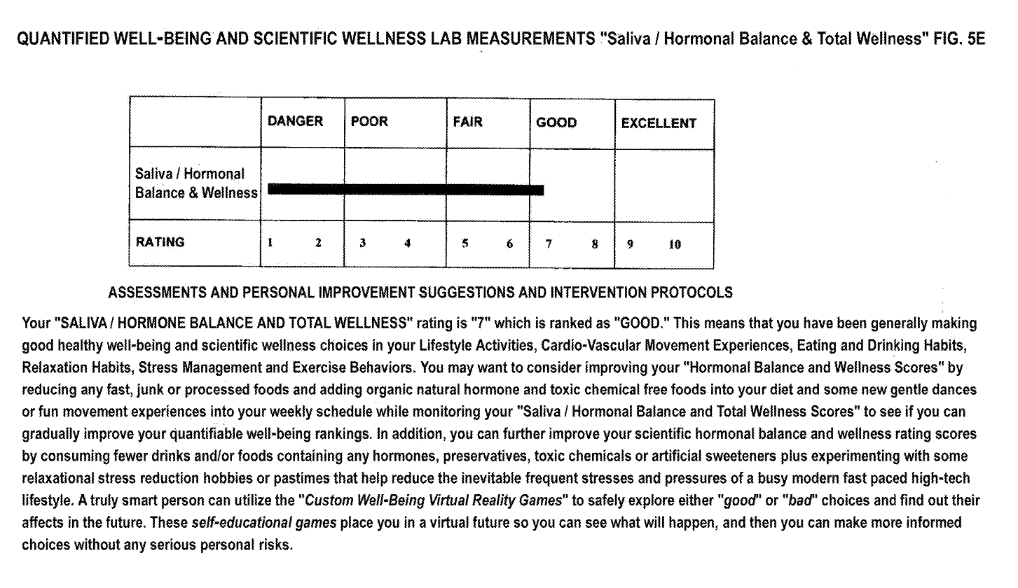

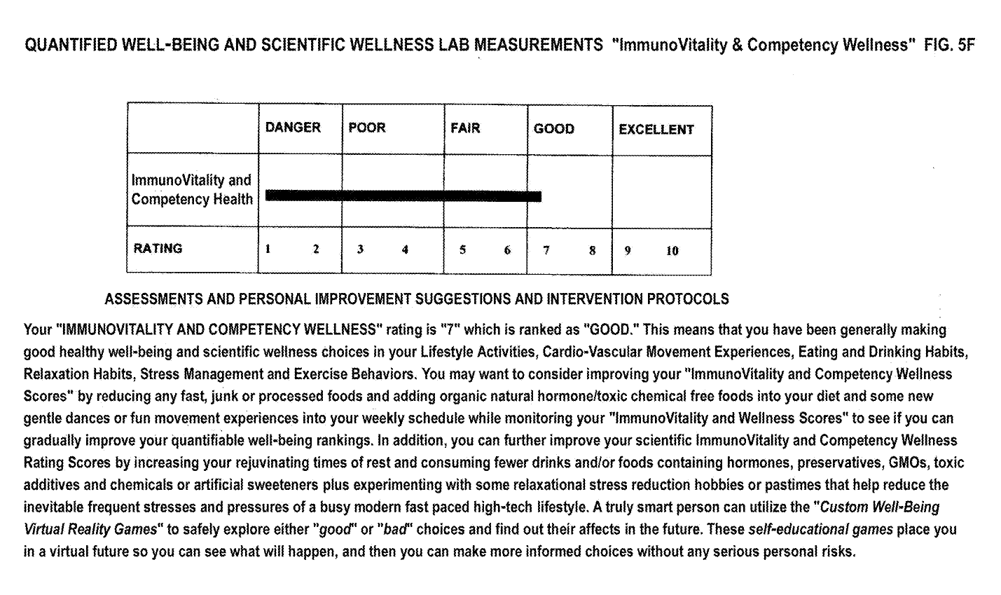

### FIGS. 5A-5F. Biological and Physio-Chemistry Lab Tests and Evaluations

### Lab Analyzed Hidden Measurements of Comprehensive Biological and Physio-Chemistry Laboratory Tests and Evaluations Bio-PhysioLabChemistry Scientific Well-Being Parameters

### FIG. 5A. Extremely Important Blood Lipid Chemistries

FIG. 5A. is a reproduction of the individualized and personal Super-Health, Quantifiable Scientific Well-Being, Optimal Wellness and Ideal Fitness multicolor visual depictions and analysis information showing the participant's ranking on subjective aspects of the 10-Point Quantifiable Parameters categorized as the Extremely Important Biological Physio-Chemistry Laboratory Tests and Evaluations of Blood Lipid Chemistries that's combined with the highlighted recommendations and simple suggestions that are correlated to this specific updated and improved summary and ranking on the “10-Point Regular Extremely Important Biological Physio-Chemistry Laboratory Tests and Evaluations of Quantifiable Scientific Well-Being, Optimal Wellness, Ideal Fitness and Cardiovascular Health.”

Simple one drop lab blood lipid evaluations can measure and track a number of significant indicators of Super-Health, Quantifiable Scientific Well-Being, Optimal Wellness and Ideal Fitness. However, these tests should be verified with full lab tests, especially if any potential risk factors may be found. This information is very important data that needs to be monitored and tracked for many improvement protocols, since blood lipid ranges provide quantifiable scientific well-being and optimal wellness professional experts with valuable information of how healthy a person really is deep inside their body, plus they are accurate indicators of many hidden biological/physio-chemistry indicators of cardiovascular conditions that may lead to certain serious risk factors. Blood is a very vital fluid that circulates throughout the entire body. A careful observation of lab analyzed ingredients may provide objective indicators of the scientific well-being and optimal wellness levels of a person as well as any early indicators of potential risk factors.

If serious health risk factors are present in the lab data, the Quantifiable Scientific Well-Being and Optimal Wellness System will alert the individual about the potential risks and suggest some realistic intervention protocols and suggestions, including seeking care from a competent medical practitioner. The smart people using this Quantifiable Scientific Well-Being and Optimal Wellness System will be grateful for the valuable scientifically accurate information that is at their fingertips through the “Quantifiable Scientific Well-Being Output Reports, Computerized Print Outs, Customized Intervention Protocols, Scientifically Customized Fun Scientific Well-Being and Optimal Wellness Computerized VR (3D) Games and the Suggestions for Improvement that can be accessed via their smart phones, tablets, lap tops or the Internet.

In this Blood Lipid Parameter, a careful evaluation is performed on the following: total cholesterol, high density lipoproteins (HDL), low density lipoproteins (LDL), triglycerides, glucose and sugars, proteins, and other ingredients as needed. It is primarily the Cholesterol, Triglycerides, LDLs and the HDLs and their ratios or relationships that determine one's cardiovascular health or risk levels. In an analysis of these ingredients, the primary concern is with the ones which relate to the most important areas of Quantifiable Scientific Well-Being and Optimal Wellness, such as: High-Density Lipoproteins (HDLs), Low-Density Lipoproteins (LDLs), Total Cholesterol, and Triglycerides.

The Quantifiable Scientific Well-Being and Optimal Wellness System does not ignore the high-risk levels in these blood lipids. Instead, its main positive oriented purposes and objectives are not to identify or diagnose an illness, but to assist smart people who wish to explore the Quantifiable Scientific Well-Being and Optimal Wellness data and related alternative safe valuable information in order to gradually improve their personal levels of super-health, quantifiable scientific well-being, optimal wellness and ideal fitness.

Other Biological Blood Physio-Chemistry Ingredients can be important, but they are not usually related to achieving and maintaining the most important areas of concern, because they do not relate to the number one and two major causes of catastrophic diseases or mortality factors. Scientific research has shown that high “Cholesterol” alone is not a very significant number. Many people are aware of the risks and potential dangers of ultrahigh levels of Cholesterol, because it is vital in objectively measuring a person's levels of stress and tracking achievable levels of quantifiable scientific well-being, optimal wellness, super-health and ideal fitness. For example, when a person experiences a deep and serious emotional loss of a loved one, their total “Cholesterol” has been known to go over 600 (where the average optimal healthy range is generally between 170 to 180).

Much more important than one's level of Total Cholesterol Measurement is the lab evaluated ratios of Cholesterol to HDL as well as LDL to HDL, because these can significantly correlate to cardiovascular health or disease. One of the most important laboratory measurements is the Cholesterol to HDL ratio, and the LDL Score, which is healthiest if it is kept under 120 in order to maintain a Low-Risk Level. The LDL to HDL Ratio is also a very important indicator of either scientific well-being and optimal wellness or potentially dangerous high-risk.

The measurement of the Triglycerides, too, is important because as lipids they are especially important for evaluating and calculating the amount of low density lipids (LDLs) in the blood stream and in monitoring achievable levels of Quantifiable Scientific Well-Being, Optimal Wellness and Ideal Fitness. Triglycerides determine a major portion of the overall risks of cardiovascular dysfunction since they contribute to higher levels of the LDLs. High Scores may also indicate a significant consumption of alcohol and/or sweets. LDLs, the unwanted lipids, are the dangerous low-density lipids (LDLs) in the blood stream that can easily cause serious and sudden blockages (occlusions) in the arteries or veins. The “Total Cholesterol to HDL Ratio Scale” is one of the most important numbers to know in predicting and preventing cardiovascular diseases because it reveals the hidden level of cardiovascular risk or well-being in the circulatory system. Often high levels of LDLs and Cholesterol go unnoticed because most people cannot feel escalated levels of these lipids.

### FIG. 5B. Optimal Endocrine Health and Total Wellness

FIG. 5B. is a reproduction of the individualized and personal Super-Health, Quantifiable Scientific Well-Being, Optimal Wellness and Ideal Fitness multicolor visual depictions and analysis information showing the participant's ranking on subjective aspects of the 10-Point Quantifiable Parameters categorized as “Optimal Endocrine Health and Total Wellness” that features highlighted recommendations and simple suggestions that are correlated to this specific summary and ranking on the “10-Point Optimal Endocrine Health and Total Wellness Scales.”

Since the turn of the century, numerous ethical wellness researchers have been evaluating the importance, roles and contributions of the human body's Endocrine System to achievable Scientific Well-Being and Optimal Wellness. The entire Endocrine System is seriously and negatively affected by many common toxic substances that are now known to be ecological pollutants as “Endocrine Disruptors,” because they are causing unwanted changes to the worlds ecosystem as evidenced by certain forms of DNA mutations of wildlife animals being born with an inability to reproduce, due to missing or inadequate body parts needed for reproduction.

DNA disruptors contain toxins that scramble the chromosomes and cause genetic defects in humans, even for future generations as well. An endocrine lab test can identify a genetic defect called CBS or MTFHR. If there are endocrine imbalances, it may be wise to check for ammonia in the blood and have a full panel of genetic tests. There are other important lab tests, like the provocative challenge test for heavy metals (linked to ADD). These may be one of the biggest factors for the rising rates in autism, cancers, decreased brain function, autoimmune diseases, chronic inflammation, sterility, behavior problems and all chronic disease states.

Unfortunately, these endocrine disrupters can be found as standard ingredients in many personal care products that are widely used by millions of ignorant, uninformed consumers. Similar endocrine disrupters contribute to air pollution and can be found as ordinary ingredients in many soy products, household and cooking oils, food coloring, pasteurized dairy products, numerous plastics and Teflon cookware. Most people buying these products (many which are made in China and laced with these endocrine disrupter ingredients) are unaware of their negative and disease-causing affects in the human body. Over 30 common additives (mostly found in highly processed food products) have tested positive as endocrine disrupters.

Anyone interested in reducing future risks from innocent or naive exposure to these subtle endocrine disrupters needs to become more aware of their negative consequences. And for smart individuals wanting to improve their personal levels of Scientific Well-Being and Optimal Wellness it will be necessary to become more aware and informed of the increasing endocrine disrupter problems by increasing one's personal Endocrine Ecology Substance IQ by seriously reading more labels and becoming more alert and self-educated about the risks of blindly consuming or using any foods, household or personal care products containing these toxic endocrine disrupters that cause disease conditions in many humans, such as: earlier ages of puberty, breast cancers, low sperm counts, interference with fetus development, severe hormone imbalances, neurotransmitter diseases and/or other negative consequences to the internal terrain. Smart people dedicated to Super-Health, Quantifiable Scientific Well-Being, Optimal Wellness, Ideal Fitness and healthy longevity will probably want to consider removing most plastic items from their home and not eat any foods which have been touching plastic (especially things in plastic bags or containers that have been in a hot car).

An even better but time-consuming solution to this endocrine nightmare of escalating hidden health risks and associated problems is to eat only organic unprocessed whole foods without any GMOs or food additives (from a reliable ethical source). It is also wise to avoid any cookware with Teflon. Food and cooking oils need to be limited to only coconut oil that is cold processed and organic. All cooking pots need to be of the highest quality, and ones that will not leach any toxins (such as aluminum pots). Other positive suggestions are to make your own natural cleaning products, and store all others in a garage. Adding house plants in your home to get more life enhancing oxygen can improve your air quality and help with detoxification.

### FIG. 5C. Vital Blood Glucose Health and Total Wellness

FIG. 5C. is a reproduction of the individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the Vital Blood Glucose Health and Total Wellness that is combined with the highlighted recommendations and simple suggestions that are correlated to this specific summary and ranking on the “10-Point Vital Blood Glucose Health and Total Wellness Scales.”

The demands and pressures of active modern lifestyles of most functional human beings require enormous amounts of energy (fuel) for optimal functioning. Vital Blood Glucose is one the most important fuels for the body. Due to the high demands for energy needed to perform most demanding jobs, many individuals have developed unhealthy eating and drinking habits consuming highly sweetened sodas, gourmet coffees, energy sweets or snacks, and fast or processed foods that are high in sugars or carcinogenic artificial sweeteners. Unfortunately, these survival behaviors have led to dramatic increased incidents of hypoglycemic or diabetic conditions. Eating out or consuming standard super-market processed consumables will generally expose even a normally super-healthy person to increased levels of unwanted blood glucose as well as many carcinogenic ingredients. One creative solution to this growing challenge is to bring one's own home prepared meals and snacks, so that all the ingredients are known to be organic, non-GMO and non-toxic.

### FIG. 5D. Excretory Health and Urine Wellness

FIG. 5D. is a reproduction of the individualized and personal Super-Health, Quantifiable Scientific Well-Being, Optimal Wellness and Ideal Fitness multicolor visual depictions and analysis information showing the participant's ranking on subjective aspects of the 10-Point Quantifiable Parameters categorized as Excretory Health and Urine Wellness that is combined with the highlighted recommendations and simple suggestions that are correlated to this specific updated and improved summary and ranking on the “10-Point Excretory Health and Urine Wellness Scales.”

Eliminating waste products, heavy metals, toxins, parasites, pathogens and other unwanted substances from the human body is the challenging task of liver and the excretory systems. This is not an easy job, even for many super-healthy individuals. Consequently, the super-smart person who is passionately dedicated to achieving and maintaining quantifiable scientific well-being, optimal wellness and longevity will occasionally want to have their urine analyzed by a quality laboratory in order to check for parasites, the presence of infectious pathogens, pesticides, other toxic chemicals or substances, excessive amounts of sugars, unbalanced pH, etc. Urine comes from the excretory system, and its pH, sugars and color generally reflects the overall health and wellness of the person. Lab evaluations of the pH, sugars and color of a person's urine provide additional important quantifiable scientific well-being and optimal wellness data that needs to be periodically measured and tracked for a person's level of health risks. Additionally, the urine should be lab analyzed periodically for sulfites, other sulfur compounds, carcinogens and any pesticides.

### FIG. 5E. Saliva Hormonal Balances and Total Wellness

FIG. 5E. is a reproduction of the individualized and personal Super-Health, Optimal Wellness, Quantifiable Scientific Well-Being and Ideal Fitness multicolor visual depictions and analysis information showing the participant's ranking on objective aspects of the 10-Point Quantifiable Parameters categorized as the “Hormonal Balances and Total Wellness” that is combined with the highlighted recommendations and simple suggestions that are correlated to this specific updated and improved summary and ranking on the “10-Point Hormonal Balances and Total Wellness Scales.”

It is usually difficult for most people to understand the subtle energy indicators of small or minor variations in their hormone levels or to feel significant changes and differences in one's ability to function when the hormones are even slightly out of balance. Lab tests of saliva generally offer the best source of information for evaluating hormonal balances. Healthy saliva is also one of the first and best defense systems in the human organism against unwanted organisms. When compared to popular (even expensive) commercial antibacterial mouth washes available everywhere, none of them come even close to healthy saliva as a safe non-toxic biocidal (germ killing agent) substance. Many decades ago, longevity experts conducted unpublished (for obvious reasons) ethical research studies comparing the most popular mouth rinses to healthy saliva (Sputum) as bacterial anti-microbial substances. Saliva is produced from glands in the mouth and is an indicator of the scientific well-being and optimal wellness of the person. There was a significant difference in the speed or kill ratios between the best commercial germ-killing products and the healthy saliva.

It has been known for a long time, that one of the major normal functions of the “good” bacteria and probiotic organisms includes their feeding on the bad pathogenic bacteria to slow down and control their population growth. Surprising as it may be, the healthy sputum eliminated all of the pathogenic organisms more than twice as fast as the commercial mouth washes. But there was a significant surprise to the researchers between the two germ killing agents. The toxic mouth rinse killed both good (probiotic organisms) and bad pathogens. This complete genocide (killing) of all micro-organisms left the mouth very vulnerable to the rapid astronomical growth of unwanted bacteria (which can replicate or grow over one million pathogenic organisms in a single day) if there are no “good” bacteria (like healthy saliva, nature's best anti-bacterial agent) present to control their population explosion. Repeated use of the mouth rinses only made the unwanted germ problems worse, because the “good” bacteria in the saliva did not replicate as fast as the pathogenic organisms.

In all cases researched, the genocidal actions of the saliva only targeted pathogenic organisms. The same research revealed another unexpected surprise. The healthy saliva exhibited unique properties that came to be known as “selective genocide.” None of the “good” or probiotic bacteria when exposed to the healthy sputum were harmed or killed. This phenomenon had some beneficial anti-germ effects for the super-healthy human's mouth ecology. Avoiding the popular commercial germ-killing mouth washes, breath fresheners and popular tooth pastes increased the super-healthy person's chances of rarely, if ever, experiencing a common cold or any flu symptoms.

### FIG. 5F. Total Immune System Vitality, Immunocompetency & NKHT Evaluation

FIG. 5F. is a reproduction of the individualized and personal Super-Health, Optimal Wellness, Quantifiable Scientific Well-Being and Ideal Fitness multicolor visual depictions and analysis information showing the participant's ranking on the objective aspects of the 10-Point Quantifiable Parameters categorized as the Immuno-Vitality and Competency Wellness based on lab tests that is combined with the highlighted recommendations and simple suggestions that are correlated to this specific updated and improved summary and ranking on the “10-Point Immuno-Vitality and Competency Wellness Scales.”

Around the world, there is a steady increase in modern immune disorders, plus a serious reduction in many individual's “Total Immunocompetency.” This has resulted in an escalation of major risk levels of immune disorders/diseases, cancers, tumors or AIDS. Smart people will appreciate the immunocompetency lab blood analyzes available to them as part of the Super-Health, Quantifiable Scientific Well-Being, Optimal Wellness, and Ideal Fitness Measurements.

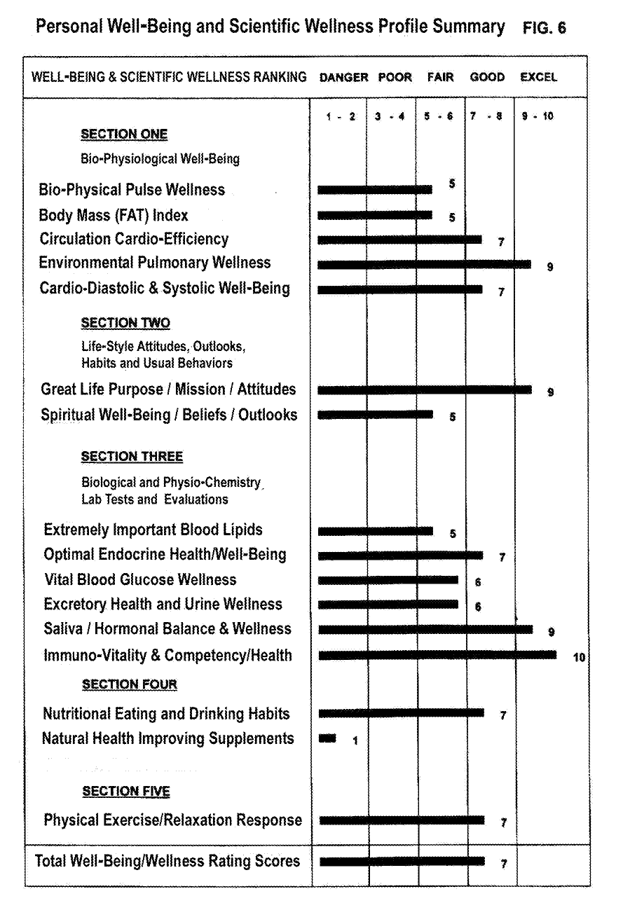

FIG. 6 is a reproduction of a typical example and portion of the individualized personal 10-Point Quantifiable Scientific Well-Being and Optimal Wellness Rating Chart and multicolor summary evaluation that graphically depicts (dangerous ratings are in RED) on one page all of the various rankings of the validated specified 10-Point Scales included in a standard report. This chart gives participants a quick graphic summary view of their entire report. It provides the person a graphically depicted overview of all the results of the tests and measurements that are included in the “Output Report and Follow-Up Improvement Suggestions and Intervention Protocols plus it specifically relates to some of the individualized scenarios and options in the Customized Fun Super-Health, Scientific Well-Being, Optimal Wellness and Ideal Fitness Computerized VR (3D) Games.”

The invention thus sets forth comprehensive total scientific well-being and optimal wellness schemes which, if followed by an individual, generally result in a longer, optimally healthy and more fulfilling life. Various changes can be made to the invention without departing from the spirit thereof or scope of the appended claims.

### Objects of the Quantifiable Scientific Well-Being Invention

It is an important object of the present invention to provide a neoteric, actuarially, scientifically objective, updated and adjusted data analysis that is based upon continuous increasingly stringent scientific well-being algorithms and optimal wellness research on living super-healthy humans. This technology is capable of quantifying and validating pre-determined stringent scientific well-being rankings according to the invention's methods for assessing, measuring, evaluating, analyzing, interpreting, quantifying and repeated tracking of small incremental changes in optimal measurable quantifiable scientific well-being, super-health, optimal wellness and ideal fitness indicators and levels as well as any risk-related medical conditions or factors (if any).

It is further an object of the present invention to provide a completely neoteric, actuarially, scientifically objective, updated, quantifiably verified/validated and advanced method for assessing, measuring, evaluating, analyzing, interpreting, quantifying and repeatedly tracking small incremental changes in personal scientific well-being, and/or optimal wellness, as well as any major and minor health risks including deteriorating or debilitating changes in the human cardiovascular and/or immune systems.

It is also an object of the present invention to encourage and facilitate a maximum number of participants in making positive small quantifiable improvements in their measured levels of scientific well-being, total wellness and personal health/fitness levels. The invention utilizes clear output reports, intervention programs and custom VR Games to facilitate making consistent positive changes in participant's life purpose and mission choices, outlooks and attitudes, basic core beliefs, nurturing/healthy/happy relationships, increased self-love, improved mental/emotional health and balance, healthier eating and drinking behaviors that are frequently combined with gentle fun non-stressful movement and exercise habits including other important improvements in one's lifestyle choices and behaviors.

It is an additional object of the present invention to provide a neoteric, actuarially, scientifically objective, improved, updated, quantifiably verified/validated and advanced method for assessing, measuring, evaluating, analyzing, interpreting, quantifying and repeatedly tracking of small incremental changes wherein the subject matter of the areas of assessment, evaluation and quantification are expanded to include significant measurements and evaluations of the most important attitudinal, life purpose/mission, spiritual, psychological, emotional, social, bio-physiological, immuno-virility, stress reduction, nutritional and laboratory wellness parameters utilizing many modern advanced high-tech data and information gathering devices, documents, smart phone Apps, forms and sources of data collection and pertinent information collected through advanced self-administered bio-physiological measurements or those taken by trained and certified wellness/well-being technicians/professionals, objective laboratory blood and urine analyses, all of which are compared to scientifically weighted, quantified and validated wellness parameters, categories and data bases which measure, evaluate, compare, correlate, interpret, quantify and track up to approximately 40+ factors of quantifiable scientific well-being, optimal wellness, super-health and/or total fitness in order to provide a more objective and comprehensive variety of valuable and reliable analytic information and data for informed lifestyle choices.

Another object of the present invention is to provide a neoteric, objective, improved, quantifiable, validated and advanced method for assessing, measuring, evaluating, interpreting, quantifying and tracking small incremental changes in nutritional, dietary, eating and drinking habits that are actuarially cross-correlated to the bio-physiological and scientifically validated laboratory tests and measurements of quantifiable scientific well-being, super-health, optimal scientific wellness, total fitness levels and optimum brain function.

A further object of the present invention is to provide a neoteric, objective, improved, quantifiable, validated and advanced method for assessing, measuring, evaluating, interpreting, quantifying and tracking small incremental changes in physical exercise, gentle body movement, flexibility, other physical activities and fulfilling healthy hobbies and mentally stimulating activities.

Still another object of the present invention is to provide a neoteric, objective, improved, quantifiable, validated and advanced system and method for measuring, evaluating, interpreting, quantifying and tracking small incremental changes in the attitudinal, spiritual, psychological, physiological and biochemical effects of successfully reducing and managing life's stressors plus any changes in the sources, intensity levels and coping skills of the participant with regards to relaxational abilities, stress reduction or management skills and/or reducing high levels of extreme lifestyle and occupational pressures as well as life's uncontrollable pains, challenges and distresses.

Another extremely important and vital object of the present invention is to provide participants with valuable information in a neoteric, objective, improved, quantifiable, validated and advanced manner with proven methods for measuring, evaluating, interpreting, quantifying and tracking small incremental changes in quantifiable scientific well-being, optimal wellness and total health or fitness levels by means of comparing and cross-correlating the different expanded areas of investigative tests and measurements and the resulting information so that the participating individual can clearly understand the unknown and undetected hidden risk factors that are caused by unhealthy eating and drinking habits, certain self-destructive behaviors, abuse of toxic substances, poor stress management skills and mental attitudes as well as one's core beliefs, and/or highly sedentary lifestyles, including the lack of an important life purpose and no regular consistent gentle cardiovascular exercises.

An important and valuable object of this invention includes comparing and contrasting self-reported subjective information with objective data that has been collected by certified wellness technicians and scientifically verified lab analyzed data of body fluids. The knowledge and data that comes from these three types of individual assessments are actuarially correlated via quantifiable scientific well-being and optimal wellness database software in order to create a unique series of individualized detailed VR Games, clear output reports and visually accented graphs with graduated ranking numerical scales based on 10-Point Quantifiable Scientific Well-Being and Optimal Wellness Scales and Custom Factoring Formuli that also includes quantifiable evaluations, suggestions for improvement, recommendations and proven protocols for interventions, and risk reduction strategies for improving a person's scientific well-being rankings. Thus, this invention includes scientifically accurate evaluative commentary and improvement suggestions and intervention protocols so smart participants can be informed of and directed to specific causative categories that have been identified and taken into consideration as conditions which may be outside of such categories but which have an actual negative impact upon the evaluative commentary and suggestions given to the participant.

It is also an object of this invention to continuously update the ever increasing stringent scientific well-being algorithms and optimal wellness research over the past several decades on living super-healthy humans, in order to revise and update the unique 10-Point Quantifiable Scientific Well-Being and Optimal Wellness Scaling and Factoring Formuli including quantifiable evaluations, complete with suggestions and recommendations and protocols for improvement interventions, along with customized follow-up user friendly VR Games and other educational programs specifically created for each individual's quantifiable personal scientific well-being needs and potentially achievable outcomes and health benefits.

Still another object of the present invention is aimed at assisting the participant to understand the purpose, meaning and importance of the unique Quantifiable Scientific Well-Being and Optimal Wellness Evaluation Procedures, the reasons for the comprehensive battery of tests and measurements that are utilized to determine individual levels of super-health, optimal wellness, achievable scientific well-being and total fitness and the validated reasons for combining attitudinal, spiritual, emotional, psychological, bio-physiological and laboratory assessments of endocrine wellness for greater accuracy and objectivity in analyses, interpreting and tracking of both positive and negative small incremental changes in scientific well-being, super-health, optimal wellness, total fitness and/or any potentially serious health risks.

Further included among the objects of the present invention is a method to provide objective, improved, quantifiably validated and advanced measuring, evaluating, interpreting, quantifying and tracking small incremental changes in scientific well-being, optimal wellness, general health and ideal fitness levels which includes well-designed graphically pleasing persuasively presented personal reports in a manner such that the participant need have no knowledge or appreciation of the sophisticated data gathering devices, methods, phone Apps, forms, questionnaires, documents, VR Games or sources of information and/or the computerized suggestions but need only be capable of understanding the meaning of the simple 10-Point Quantifiable Scientific Well-Being and Optimal Wellness Scales and the reading of simple, easy to comprehend, layman like non-medical language and figures, brought to the participant's attention in a graphic fashion which itself is designed and formulated to have a positive and persuasive effect upon the quantifiable improvement and ultimate dedication towards improvement and compliance of the participant.

It is a further object of the present invention to help each participant understand the meaning of pending and potentially serious health risks taking into consideration the correlations and relationships to one's personal life-style choices and consistent poor health habits and any negative behavior patterns which may ultimately lead to potential catastrophic morbidity or mortality. In this manner, the invention helps the participant realize that such avoidable risks can personally apply to the participant, which indicates by the commentary and improvement suggestions the relative importance of the measurements of quantifiable scientific well-being and optimal wellness, including evaluations of poor health habits and lifestyle risks, thereby enabling the participant to be able to make wise and informed choices as to which chronic choices, unhealthy behavior patterns and risky habits to eliminate; which by commentary and improvement suggestions and protocols convey a sense of urgency to assist in motivating the individual to make positive and measurable improvement changes, and which provides a bench mark process for observing on-going positive small incremental measurement of improved overall wellness and total scientific well-being levels and observable reductions in major risk factors if certain poor and/or dangerous health attitudes, choices and bad habits are altered or eliminated.

An additional object of the present invention is designed to show a person that how one lives, believes and behaves will become a determinant and a causative factor leading to most of the debilitating and preventable catastrophic diseases experienced by many dumb humans and/or how the person may die; which demonstrates through awareness concepts the importance of risk reduction/management and the ultimate effects and outcomes of risk-taking, showing that personal chronic unhealthy habits and behavioral risks not only add to one's painful problems and stresses, but compound one another; which personalizes the information in the quantifiable scientific well-being and optimal wellness methods for achieving, maintaining optimal health and “Staying Well” through consistent healthy lifestyle outlooks/habits and the reduction of any discovered preventable risks.

A vitally important object and feature of the present invention are high-tech customized computer-generated VR Games that motivate participants with follow-up improvement games and scenarios oriented for easy intervention applications adapted to PCs, tablets, smart phones Apps, and/or copied to a DVD format. These customized “Virtual Reality Actuarially Customized Fun Scientific Well-Being and Optimal Wellness Computerized Video (3D) Games,” allow a participant to become involved in a series of games that uniquely and graphically demonstrate to the participant the probable and/or guaranteed realistic outcomes and consequences of either “positive” self-improvement or “negative” self-destructive lifestyle choices specifically related to the self-reported subjective information of the participant, plus the empirical collected data and measurements taken by certified wellness technicians and the objective lab evaluations of body fluids and their associated “Validated Quantifiable Scientific Well-Being and Optimal Wellness Scales.”

It a further object of this invention to design and update the “VR Games” in such a manner that they can help self-educate truly smart individuals as they play the games, by following the suggestions of the Avatar they have created and by experimentation with the various intervention protocols to create new and improved ways to cope with life's many surprises and unprecedented challenges and learn valuable information from the adventurous “VR Games” by following the individualized scenarios of alternatively choosing apparent positive and/or clearly negative choices in the game's adventures which can then lead to realistic probable outcomes and consequences plus many personal scientific well-being and optimal wellness rewards. The beauty of the custom VR self-educational Games is that a person can safely and realistically explore life experiences, good and bad choices, different dramas and their probable outcomes and consequences without any serious, painful or devastating personal well-being and/or scientific wellness damages. Over time, one can learn to improve their own personal scientific well-being and optimal wellness scores to the point that they can share their successes and the VR Games with family, friends and business associates.

With these and other objects in view, the present invention consists of the arrangement, combination and implementation of the various Super-Health, Quantifiable Scientific Well-Being, Optimal Wellness and Ideal Fitness Tests and Measurements providing raw data which can be inputted into a phone App, tablet device, PC or kiosk computer screen which when connected to the Internet can transmit said data to a processing computer which then assesses, evaluates, compares and contrasts the data to the quantified, correlated, validated and frequently updated and revised proprietary super-health, scientific well-being, optimal wellness and ideal fitness databases, resulting in the processing of the data to create an individualized output report which graphically indicates each rank and rating of comprehensive self-reported and/or certified wellness technician or laboratory measured super-health, quantifiable scientific well-being, optimal wellness and ideal fitness levels on a series of up to 40 or more special 10-Point Scales with simple graphics, appropriately ranked personalized evaluative comments and suggestions in layman like language and figures, brought to the participant's attention in a easily understood fashion which itself is designed and formulated to have an ever increasing positive and persuasive effect upon the ultimate compliance of the participant together with other aspects of the method, serving as an example only of one or more embodiments of the invention, whereby the objects contemplated are attained, as disclosed in the specifications, and pointed out in the appended claims.

1. A method comprising:
(a) collecting a variety of self-reported subjective and somewhat objective input data from a participant, such as: answers to a Well-Being 10-Point Ranked Questionnaire, self-reported test results of physiological or lab data submitted via a smart phone, tablet, kiosk, a special App or a Secure Internet Transmission that the participant has submitted or experienced which can then be correlated to Specific Well-Being 10-Point Ranked Scales;
(b) determining and weighting the subjective and somewhat objective levels of the input data and how it indicates well-being choices, attitudes, beliefs, values, life purpose as well as the key chronic lifestyle, major health habits and behavior patterns of a participant;
(c) submitting the input data into the Validated 10-Point Super-Health, Quantifiable Scientific Well-Being, Optimal Wellness and Ideal Fitness Data Base;
(d) comparing and contrasting the participant's subjective input data to other validated super-healthy, optimally well and ideal fitness data as well as associated, verified and potential genetic, medical and/or health related-risks;
(e) converting the input data into empirical data in order to create a scheme that generates individualized Specific Well-Being 10-Point Ranked Output Graphic Reports;
(f) further converting the input data into empirical data in order to generate custom individualized intervention programs with specific details pertinent to the participant;
(g) additionally, converting the input data into empirical data in order to create individualized VR Games that reflect the uniqueness of the participant;
(h) applying a scheme within the data base to create user-friendly graphically designed output reports and charts depicting the quantified levels of “Scientific Well-Being” of the participant, according to any of the “Assessed Well-Being Parameters” that the participant has submitted or experienced;
(i) applying a scheme within the data base to create customized intervention protocols and programs which are user-friendly and correlated to the actual quantified levels of “Scientific Well-Being” of the participant, according to any of the “Assessed Well-Being Parameters” that the participant has submitted or experienced; and, when applicable,
(j) providing participating groups/organizations/businesses (if any) with customized risk management protocols, specialized intervention programs and actuarially based cost containment strategies that can positively affect the bottom line; and,
(k) additionally, applying a scheme within the data base in order to create personalized VR Games with realistic positive and negative lifestyle choices for the individualized VR Games;
(l) continually updating and revising positive and/or negative lifestyle choices made by any participants as the VR Games are repeatedly played, and/or new updated empirical data becomes available from additional tests and measurements;
(m) altering and updating the probable outcomes in the VR Games to be indicative of any changing scientific well-being levels, health attitudes adjustments and positive or negative behavior modifications of the participant; and, when applicable,
(n) providing participating groups/organizations/businesses (if any) with customized risk management protocols, specialized intervention programs and actuarially based cost containment strategies that can measurably alter the bottom line; and, when applicable,
(o) additionally, applying a scheme within the data base in order to create participating group VR Games with realistic positive and negative lifestyle choices for the individuals participating in the Group VR Games.

2. The method according to claim 1, further comprising:
(p) collecting a variety of well-being technician reported objective input data for the participant, such as: actual test results of bio-physiological data submitted via a smart phone, tablet, kiosk, a special App or a Secure Internet Transmission that the participant has experienced which can then be correlated to Specific Well-Being 10-Point Ranked Scales;
(q) determining and weighting the objective levels of the input data and how it indicates well-being choices, attitudes, beliefs, values, life purpose as well as the key chronic lifestyle, major health habits and behavior patterns of the participant;
(r) submitting the objective input data into the Validated 10-Point Super-Health, Quantifiable Scientific Well-Being, Optimal Wellness and Ideal Fitness Data Base;
(s) comparing and contrasting the participant's input data to other validated super-healthy, optimally well and ideal fitness data as well as associated, verified and potential genetic, medical and/or health related-risks;
(t) converting the objective input data into empirical data in order to create a scheme that generates individualized Specific Well-Being 10-Point Ranked Output Graphic Reports;
(u) further converting the objective input data into empirical data in order to generate a custom individualized intervention program with specific details pertinent to the participant;
(v) additionally, converting the input data into empirical data in order to create individualized VR Games that reflect the uniqueness of the participant;
(w) applying a scheme within the data base to create user-friendly graphically designed output reports and charts depicting the quantified levels of “Scientific Well-Being” of the participant, according to any of the “Assessed Well-Being Parameters” that the participant has experienced;
(x) applying a scheme within the data base to create customized intervention protocols and programs which are user-friendly and correlated to the actual quantified levels of “Scientific Well-Being” of the participant, according to any of the “Assessed Well-Being Parameters” that the participant has submitted or experienced; and, when applicable,
(y) providing participating groups/organizations/businesses with customized risk management protocols, specialized intervention programs and actuarially based cost containment strategies that can positively affect the bottom line; and,
(z) additionally, applying a scheme within the data base in order to create personalized VR Games with realistic positive and negative lifestyle choices for the individualized VR Games;
(aa) continually updating and revising positive and/or negative lifestyle choices made by any participants as the VR Games are repeatedly played, and/or new updated empirical data becomes available from additional tests and measurements;
(bb) altering and updating the probable outcomes in the VR Games to be indicative of any changing scientific well-being levels, health attitudes adjustments and positive or negative behavior modifications of the participant; and, when applicable,
(cc) providing participating groups/organizations/businesses with customized risk management protocols, specialized intervention programs and actuarially based cost containment strategies that can measurably alter the bottom line; and, when applicable,
(dd) additionally, applying a scheme within the data base in order to create participating group VR Games with realistic positive and negative lifestyle choices for the individuals participating in the Group VR Games.

3. The method according to claim 1, further comprising:
(ee) collecting a variety of scientific well-being laboratory reported objective input data for the participant, such as: blood, urine, sputum or other lab test results of laboratory data submitted via a smart phone, tablet, kiosk, a special App or a Secure Internet Transmission that the participant has experienced which can then be correlated to the appropriate Specific Well-Being 10-Point Ranked Scales;
(ff) determining and weighting the objective levels of the lab input data and how it indicates well-being choices, attitudes, beliefs, values, life purpose as well as the key chronic lifestyle, major health habits and behavior patterns of the participant;
(gg) submitting the objective laboratory input data into the Validated 10-Point Super-Health, Quantifiable Scientific Well-Being, Optimal Wellness and Ideal Fitness Data Base;
(hh) comparing/contrasting the participants lab input data to other validated super-healthy, optimally well and ideal fitness data as well as associated, verified and potential genetic, medical and/or health related-risks;
(ii) converting the objective lab input data into empirical data in order to create a scheme that generates individualized Specific Well-Being 10-Point Ranked Output Graphic Reports;
(jj) further converting the objective lab input data into empirical data in order to generate a custom individualized intervention program with specific details pertinent to the participant;
(kk) additionally, converting the lab input data into empirical data in order to create an individualized VR Game that reflects the uniqueness of the participant;
(ll) applying a scheme within the data base to create user-friendly graphically designed output reports and charts depicting the quantified levels of “Scientific Well-Being” of the participant, according to any of the “Assessed Well-Being Parameters” that the participant has experienced;
(mm) applying a scheme within the data base to create customized intervention protocols and programs which are user-friendly and correlated to the actual quantified levels of “Scientific Well-Being” of the participant, according to any of the “Assessed Well-Being Parameters” that the participant has experienced; and, when applicable,
(nn) providing participating groups/organizations/businesses with customized risk management protocols, specialized intervention programs and actuarially based cost containment strategies that can positively affect the bottom line; and,
(oo) additionally, applying a scheme within the data base in order to create personalized VR Games with realistic positive and negative lifestyle choices for the individualized VR Games;
(pp) continually updating and revising positive and/or negative lifestyle choices made by any participants as the VR Games are repeatedly played, and/or new updated empirical data becomes available from additional tests and measurements;
(qq) altering and updating the probable outcomes in the VR Games to be indicative of any changing scientific well-being levels, health attitudes adjustments and positive or negative behavior modifications of the participant; and, when applicable,
(rr) providing participating groups/organizations/businesses (if any) with customized risk management protocols, specialized intervention programs and actuarially based cost containment strategies that can measurably alter the bottom line; and, when applicable,
(ss) additionally, applying a scheme within the data base in order to create participating group VR Games with realistic positive and negative lifestyle choices for the individuals participating in the Group VR Games.

4. A method within the “Scientific Well-Being Data Base,” comprising:
creating a scheme which correlates, contrasts and compares a variety of well-being subjective and objective input data for the participant on each of the tested Specific Well-Being 10-Point Ranked Scales that the participant has submitted or experienced.

5. The method according to claim 4, further comprising:
creating a scheme which generates individualized output reports and charts of each individual participant that have been correlated and compared to each of the tested Specific Well-Being 10-Point Ranked Scales that the participant has submitted or experienced.

6. The method according to claim 4, further comprising:
creating a scheme which generates individualized intervention protocols and customized well-being improvement programs for the individual participant that have been correlated and compared to each of the tested Specific Well-Being 10-Point Ranked Scales that the participant has submitted or experienced.

7. The method according to claim 4, further comprising:
creating a scheme which generates individualized VR Games which include all of the group's participants that have been correlated and compared to each of the tested Specific Well-Being 10-Point Ranked Scales.

8. The method according to claim 4, further comprising:
creating a scheme which generates participating group output reports and charts of the participant's that have been correlated and compared to each of the tested Specific Well-Being 10-Point Ranked Scales.

9. The method according to claim 4, further comprising:
creating a scheme which generates group intervention protocols as well as customized well-being improvement programs for the group's participants which have been correlated and compared to each of the tested Specific Well-Being 10-Point Ranked Scales.

10. The method according to claim 4, further comprising:
creating a scheme which generates group VR Games which will include all of the group's participants which have been correlated and compared to each of the tested Specific Well-Being 10-Point Ranked Scales.
